(19) United States
(12) Patent Application Publication
(10) Pub. No.: US 2024/0315267 A1
(43) Pub. Date: Sep. 26, 2024

(54) PLANT-BASED CHEESE-STYLE PRODUCTS

(71) Applicant: Rich Products Corporation, Buffalo, NY (US)

(72) Inventors: Ernani L. Celestino, Grand Island, NY (US); Ralf Reiser, Orchard Park, NY (US)

(21) Appl. No.: 18/612,314

(22) Filed: Mar. 21, 2024

Related U.S. Application Data
(60) Provisional application No. 63/492,097, filed on Mar. 24, 2023.
(60) Provisional application No. 63/622,745, filed on Jan. 19, 2024.

(51) Int. Cl. A23C 20/02; A23L 29/00; A23L 29/212; A23L 33/21

(52) U.S. Cl. CPC A23C 20/02; A23L 29/065; A23L 29/212; A23L 33/21; A23C 2220/20

(57) ABSTRACT

Disclosed herein are plant-based cheese-style compositions and products comprising an insoluble fiber component and having improved textural properties. Also disclosed herein are methods of making such plant-based cheese-style compositions and products. In some embodiments, disclosed compositions comprise combinations of insoluble fibers, starches, oils, vegan cultured bases, and/or gums for overall texture improvement.

### CROSS-REFERENCE TO RELATED APPLICATIONS

This application claims priority to U.S. Provisional Patent Application Nos. 63/622,745, filed on Jan. 19, 2024, and 63/492,097, filed on Mar. 24, 2023, each of which is incorporated by reference herein in its entirety.

### FIELD

This disclosure relates to plant-based cheese-style compositions and products having improved textural properties and methods of making the same.

### INTRODUCTION

One of the main challenges for plant-based cheeses is improving texture by providing chewiness/springiness while also reducing stickiness and improving melt. Currently available plant proteins in plant-based cheese applications do not have the same functionality and do not provide the same textural properties as milk proteins, particularly caseins. Some of these plant proteins provide solubility for beverage applications, while some impart grainy, rough texture and beany flavor notes. There remains a need for plant-based cheese-style compositions and products having improved textural properties.

### SUMMARY

In one aspect, this disclosure relates to a plant-based cheese-style composition that may comprise: (a) an insoluble fiber comprising bamboo fiber, rice fiber, wheat fiber, oat fiber, or combinations thereof; (b) one or more starches; (c) one or more oils; (d) a vegan cultured base; and (e) water. In an embodiment, the insoluble fiber may comprise bamboo fiber in an amount ranging from about 1.5 wt % to about 4.5 wt % of the plant-based cheese-style composition. In another embodiment, the bamboo fiber may be present in an amount of about 3 wt % of the plant-based cheese-style composition. In another embodiment, the insoluble fiber may comprise an average fiber length ranging from about 30 μm to about 200 μm. In another embodiment, the insoluble fiber may comprise an average fiber length ranging from about 100 μm to about 120 μm. In another embodiment, the insoluble fiber may comprise an average fiber length of about 115 μm. In another embodiment, the insoluble fiber may comprise an average fiber thickness ranging from about 1 μm to about 40 μm. In another embodiment, the insoluble fiber may comprise an average fiber thickness of about 20 μm. In another embodiment, the one or more starches may comprise one or more emulsifying starches, one or more viscosifying starches, or a combination thereof. In another embodiment, the one or more emulsifying starches may comprise an emulsifying potato starch, and the one or more viscosifying starches may comprise a viscosifying potato starch. In another embodiment, the one or more emulsifying starches may be present in an amount ranging from about 3.5 wt % to about 9 wt % of the plant-based cheese-style composition, and the one or more viscosifying starches may be present in an amount ranging from about 9.5 wt % to about 22 wt % of the plant-based cheese-style composition. In another embodiment, the composition may further comprise one or more gums or hydrocolloids comprising gellan gum, Konjac gum, hydroxypropyl methylcellulose (HPMC), xanthan gum, or combinations thereof. In another embodiment, gellan gum may be present in an amount ranging from about 0.1 wt % to about 0.3 wt % of the plant-based cheese-style composition, Konjac gum may be present in an amount ranging from about 0.1 wt % to about 0.3 wt % of the plant-based cheese-style composition, HPMC may be present in an amount up to 0.5 wt % of the plant-based cheese-style composition, xanthan gum may be present in an amount up to 0.19 wt % of the plant-based cheese-style composition, or a combination thereof. In another embodiment, the one or more oils may comprise coconut oil, sunflower oil, canola oil, or combinations thereof. In another embodiment, the one or more oils may be present in an amount ranging from about 15 wt % to about 23 wt % of the plant-based cheese-style composition. In another embodiment, the vegan cultured base may comprise one or more bacterial strains comprising Streptococcus thermophilus, Lactobacillus delbrueckii subsp. bulgaricus, Lactobacillus delbrueckii subsp. lactis, Bifidobacterium lactis, Lactobacillus acidophilus, Lactobacillus paracasei, Lactobacillus casei, or combinations thereof. In another embodiment, the vegan cultured base may be present in an amount ranging from about 15 wt % to about 30 wt % of the plant-based cheese-style composition. In another embodiment, the composition may further comprise one or more flavoring agents, plant proteins, lecithins, preservatives, calcium-containing agents, coloring agents, pH-modifying agents, anti-caking agents, film formers, salts, sugars, or combinations thereof. In another embodiment, the composition may have increased chewiness and springiness properties and reduced stickiness properties as compared to a composition that does not comprise an insoluble fiber. In another embodiment, the composition may have improved melt properties as compared to a composition that does not comprise one or more starches, one or more oils, and a vegan cultured base.

In another aspect, this disclosure relates to a method of making a plant-based cheese-style composition, the method may comprise: (a) mixing a vegan cultured base with heated water to create a base mixture; (b) shear mixing one or more oils with the base mixture to create a dispersion of particles; (c) shear mixing an insoluble fiber with the dispersion of particles to create a fiber mixture; (d) heating the fiber mixture; (e) shear mixing one or more starches and proteins with the heated fiber mixture to create a starch-protein blend; (f) heating the blend; and (g) refrigerating the heated blend to create the plant-based cheese-style composition. In an embodiment, one or more of the pH, solids content, or moisture content of the heated blend may be adjusted prior to refrigerating. In another embodiment, the heated blend may be provided to a mold or container prior to refrigerating. In another embodiment, the method may further comprise mixing one or more gums, flavoring agents, plant proteins, lecithins, preservatives, calcium-containing agents, coloring agents, pH-modifying agents, anti-caking agents, film formers, salts, sugars, or combinations thereof to the heated water, base mixture, oil, dispersion of particles, fiber mixture, starch-protein blend, plant-based cheese-style composition, or combinations thereof. In another embodiment, the method may further comprise performing one or more additional processing steps to the plant-based cheese-style composition comprising cutting, shredding, dicing, crumbling, shaping, slicing, freezing, preserving, storing, packaging, or combinations thereof. In another embodiment, the heated water may comprise a temperature ranging from about 50° C. to about 70° C. In another embodiment, the one or more oils may be pre-heated to a temperature ranging from about 40° C. to about 60° C. prior to shear mixing with the base mixture. In another embodiment, the insoluble fiber may comprise bamboo fiber, rice fiber, wheat fiber, oat fiber, or combinations thereof. In another embodiment, the insoluble fiber may be pre-blended prior to shear mixing with the dispersion of particles. In another embodiment, the method may further comprise one or more additional heating steps. In another embodiment, heating may comprise a temperature ranging from about 55° C. to about 95° C. In another embodiment, refrigerating may comprise a temperature ranging from about 2° C. to about 7° C. In another embodiment, shear mixing may comprise a shear speed ranging between about 2,000 rpm to about 12,000 rpm or ranging between about 33 Hz to about 200 Hz.

This disclosure provides for other aspects and embodiments that will be apparent in light of the following detailed description and accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a graph comparing the measured chewiness/springiness (%) for two different plant-based mozzarella cheese-style shred compositions having either no fiber or 3 wt % insoluble bamboo fiber.

FIG. 1B is a graph comparing the measured stickiness (g force) for two different plant-based mozzarella cheese-style shred compositions having either no fiber or 3 wt % insoluble bamboo fiber.

FIG. 2 is a graph comparing the measured chewiness/springiness (%) and stickiness (g force) for four different plant-based mozzarella cheese-style shred compositions having different levels of insoluble bamboo fiber.

FIG. 3A is a graph comparing the measured chewiness/springiness (%) for two different plant-based mozzarella cheese-style shred compositions having high amounts of gelling starch and either soluble corn fiber or insoluble bamboo fiber.

FIG. 3B is a graph comparing the measured stickiness (g force) for two different plant-based mozzarella cheese-style shred compositions having high amounts of gelling starch and either soluble corn fiber or insoluble bamboo fiber.

FIG. 4A is a graph comparing the measured chewiness/springiness (%) for two different plant-based mozzarella cheese-style shred compositions having high amounts of emulsifying starch and either soluble corn fiber or insoluble bamboo fiber.

FIG. 4B is a graph comparing the measured stickiness (g force) for two different plant-based mozzarella cheese-style shred compositions having high amounts of emulsifying starch and either soluble corn fiber or insoluble bamboo fiber.

FIG. 5A is a graph comparing the measured chewiness/springiness (%) for two different plant-based mozzarella cheese-style stick base compositions having either no fiber or 3 wt % insoluble bamboo fiber.

FIG. 5B is a graph comparing the measured stickiness (g force) for two different plant-based mozzarella cheese-style stick base compositions having either no fiber or 3 wt % insoluble bamboo fiber.

FIG. 6 is a photographic comparison demonstrating the textural differences between a plant-based mozzarella cheese-style shred composition having 3 wt % insoluble bamboo fiber as described herein and various commercially available dairy-free cheese products (Comparative Examples 1-5) in a pizza melt application. Photographs of each sample were taken pre-cook and after cooking at 475° F. (246° C.) for 3 minutes in an impinger oven.

FIG. 7A is a graph comparing the measured chewiness/springiness (%) for three different plant-based mozzarella cheese-style shred compositions having either no fiber, 3 wt % insoluble oat fiber, or 3 wt % insoluble bamboo fiber.

FIG. 7B is a graph comparing the measured stickiness (g force) for three different plant-based mozzarella cheese-style shred compositions having either no fiber, 3 wt % insoluble oat fiber, or 3 wt % insoluble bamboo fiber.

FIG. 7C is a photographic comparison demonstrating the textural differences between two different plant-based mozzarella cheese-style shred compositions having either 3 wt % insoluble oat fiber or 3 wt % insoluble bamboo fiber as described herein and various commercially available dairy-free cheese products (Comparative Examples 1-7) in a pizza melt application. Photographs of each sample were taken pre-cook and after cooking at 475° F. (246° C.) for 3 minutes in an impinger oven.

FIG. 8 is a microscopic image analysis comparing the interaction and spatial distribution of lipids, proteins, and fibers between two different plant-based mozzarella cheese-style shred compositions having either no fiber or 3 wt % insoluble bamboo fiber. Confocal laser scanning microscopy was used to obtain the images.

FIG. 9A is a standard Schreiber stencil used to measure melt for the exemplary melt studies described herein.

FIG. 9B is a molding gadget used for molding cheese shred samples (8 grams) into discs (40 mm diameter, ˜4-5 mm thickness) for the exemplary melt studies described herein.

FIG. 10 is a photographic comparison demonstrating the differences in melt between two different plant-based mozzarella cheese-style shred compositions having either 3 wt % insoluble bamboo fiber or 3 wt % insoluble oat fiber as described herein and various commercially available dairy-free cheese products (Comparative Examples 1-7) using a standard Schreiber test. Photographs of each sample were taken pre-cook and after melting at 450° F. (232° C.) for 4.25 minutes in an oven on the middle rack. Each cheese shred sample was tested in duplicate (Test Sample 1, Test Sample 2).

FIG. 11 is a photographic comparison demonstrating the differences in melt and textural properties between the cheese shred samples of FIG. 10 in a pizza melt application. Photographs of each sample were taken pre-cook and after cooking at 475° F. (246° C.) for 3 minutes in an impinger oven. Each 10-inch pizza crust had 100 grams of shreds for each cheese sample.

Before any embodiments of the disclosure are explained in detail, it is to be understood that the disclosure is not limited in its application to the details of construction and the arrangement of components set forth in the following description or illustrated in the following drawings. Also, it is to be understood that the phraseology and terminology used herein is for the purpose of description and should not be regarded as limiting.

### DETAILED DESCRIPTION

The present invention is directed to plant-based cheese-style compositions and products having improved textural properties and methods of making the same.

### 1. Definitions

Unless otherwise defined herein, all technical and scientific terms used in connection with the present disclosure have the same meaning as commonly understood by one of ordinary skill in the art. The meaning and scope of the terms should be clear. In case of conflict, the present document, including definitions, will control. Preferred methods and materials are described below, although methods and materials similar or equivalent to those described herein can be used in practice or testing of the present invention. Further, unless otherwise required by context, singular terms shall include pluralities and plural terms shall include the singular. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The terms “about” or “approximately” as used herein as applied to one or more values of interest, refer to a value that is similar to a stated reference value. In certain aspects, the term “about” refers to a range of values that fall within 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

The terms “vegan” or “plant-based” as used herein refer to an ingredient, component, composition, or product that is entirely plant-based or vegetable-based in nature (i.e., not dairy-based or animal-based). The present invention discloses vegan cultured bases and plant-based cheese-style compositions and products.

The terms “chewiness” or “springiness” as used herein refer to measured textural properties that indicate levels of chewiness, firmness/hardness, cohesiveness, relaxation, and springiness of disclosed plant-based cheese-style compositions. Springiness may be defined as the distance regained by a sample during the time between the end of a first compression (or hold) and the beginning of a second compression (or hold). Chewiness may be estimated by calculating firmness/hardness × cohesiveness × springiness of a plant-based cheese-style composition. In some embodiments, chewiness and springiness are presented together as a single measured textural/viscoelastic property of a plant-based cheese-style composition. As used herein, “% chewiness” is the “% springiness” or “% relaxation,” which refer to the ratio of the force value (or the maximum peak value of the firmness at a specified distance of compression) vs. the force value after the hold. The higher the value of “% chewiness” or “% springiness” for a plant-based cheese-style composition, the more chewy or springy the composition is.

The term “stickiness” as used herein refers to a measured textural property that indicates the level of stickiness of disclosed plant-based cheese-style compositions. Stickiness may be defined as an amount of a sample that adheres to a palate or a similar test surface. In some embodiments, the level of stickiness of a plant-based cheese-style composition may be determined by measuring the stickiness force (g force) using instruments (e.g., force gauge or spring scale) that calculate the force required to pull the sample material away from a surface. The maximum negative force is the stickiness. The higher the negative value of “stickiness” force for a plant-based cheese-style composition, the stickier the composition is.

The terms “melt” or “meltability” as used herein refer to measured or visual textural properties that indicate how meltable a disclosed plant-based cheese-style composition is. “Meltability” or the melting property of a cheese product refers to the ability of the cheese product to flow or spread upon heating into a uniform, homogeneous, and smooth mass. Cheese products with poor meltability properties are typically tough and hardly stretchable, while excessive melting may result in a “soupy” appearance of a cheese. The melt or meltability of a plant-based cheese-style composition as disclosed herein may be assessed and determined using different cooking times and temperatures to calculate a melting degree and/or melting rate. The level of melt or meltability of a plant-based cheese-style composition may also be assessed and determined using visual indications.

Various quantitative techniques have previously been developed to objectively measure and define the “melt” or “meltability” of cheese products. Three well-known empirical methods include the Arnott test, the Schreiber test, and the Tube Melt test. The specific methods of these different melt tests are described in greater detail in Arnott et al., “Effect of certain chemical factors on the melting quality of process cheese,” Journal of Dairy Science 40(8): 957-963 (1957), Altan et al., “Short Communication: Comparison of covered and uncovered Schreiber test for cheese meltability evaluation,” Journal of Dairy Science 88(3): 857-861 (2005), Muthukumarappan et al., “Short Communication: Modified Schreiber test for evaluation of mozzarella cheese meltability,” Journal of Dairy Science 82(6): 1068-1071 (1999), and Olson and Price, “A melting test for pasteurized process cheese spreads,” Journal of Dairy Science 41(7): 999-1000 (1958), each of which is incorporated herein by reference in their entireties for such teachings.

Briefly, the Schreiber test involves using a standard Schreiber stencil to measure and quantify melt and spread. Specific test parameters or conditions for the Schreiber test may be modified as needed (e.g., temperature, time, type of oven, etc.). As described herein, a typical Schreiber test involves the preparation of cheese sample discs that measure about 40 mm in diameter with a thickness of about 4-5 mm. In some non-limiting experimental examples described herein, about 8 grams of cheese shreds sample are weighed and used to form the discs. The sample discs are placed on a transparent heat resistant paper (e.g., parchment paper) that is placed on top of and in the center of a Schreiber stencil on a metal tray. The discs are then heated in an oven at a specified temperature for a set period of time to melt and spread the cheese sample product. The diameter of the melt spread is measured to obtain a “final diameter” value. The final diameter value minus the initial diameter value (˜40 mm) calculates the melt value in mm. If the melt spread is not evenly round in shape, the highest readings are taken from each of the stencil quadrants, or from each of the half quadrants, and an average is calculated. This average value is then considered the final diameter. The initial diameter reading of ˜40 mm is subtracted from the final diameter to calculate the melt in mm.

### 2. Plant-Based Cheese-Style Compositions and Products

Described herein are plant-based cheese-style compositions and products. The plant-based cheese-style compositions and products may include plant-based alternatives to any type of dairy-based or animal-based cheese. Non-limiting exemplary embodiments include plant-based mozzarella cheese-style sticks, plant-based mozzarella cheese-style shreds, and plant-based feta cheese-style that may be used in various food product applications (e.g., melting and browning on pizza; melting on burgers; sandwich melts; etc.). The specific ingredients and the specific amounts and concentration ranges of ingredients may vary depending on the particular type of plant-based cheese-style composition or product, as disclosed herein.

The disclosed plant-based cheese-style compositions and products may comprise one or more insoluble fibers, starches, oils, vegan cultured bases, and water. In some embodiments, the compositions may further comprise one or more gums, flavoring agents, plant proteins, lecithins, preservatives, calcium-containing agents, coloring agents, pH-modifying agents, anti-caking agents, film formers, salts, sugars, or combinations thereof.

The disclosed plant-based cheese-style compositions and products do not utilize dairy or non-dairy milk components and are non-GMO. The plant-based cheese-style compositions and products utilize starches and oils to achieve meltability and, together with plant proteins and gums (e.g., xanthan, gellan, and/or Konjac gums), can achieve structure & shreddability following refrigeration. In some embodiments, insoluble fiber may be used for reduced stickiness and improved chewiness and springiness of the compositions. The insoluble fiber may assist with water and oil binding capacity for enhanced freeze-thaw stability and also improve opacity. The addition of a vegan cultured base contributes to texture and flavor that is similar to a dairy-type cheese through the formation of organic acids and flavor compounds. In addition, the final plant-based cheese-style compositions and products do not contain live microorganisms.

In some embodiments, the plant-based cheese-style composition may comprise a pH ranging from about 3.30 to about 5.20. Typically, the pH of the plant-based cheese-style composition will increase slightly following refrigeration as compared to the pH measured immediately after batching.

In some embodiments, the plant-based cheese-style composition may comprise a fat content ranging from about 17% to about 23%. In some embodiments, the plant-based cheese-style composition may comprise a solids content ranging from about 45% to about 58%. As used herein, “solids content” refers to the ingredients of a composition or formulation minus any added water or water from any ingredients having intrinsic water content including, but not limited to, a cultured base, flavors, and powders. In some embodiments, the plant-based cheese-style composition may comprise a moisture content ranging from about 42% to about 55%.

### A. Insoluble Fibers

As used herein, “insoluble fiber” is a plant-derived (vegetable, grain) fiber that is insoluble with respect to water. However, the disclosed insoluble fibers do imbibe, absorb, and hold excess water while retaining their structure upon freezing and thawing, creating plant-based cheese-style compositions having improved chewiness/springiness, reduced stickiness, and improved opacity. The combination of these insoluble fibers with starches, gums, and/or emulsifiers further provides for better freeze-thaw stability.

In some embodiments, the insoluble fiber may comprise one or more insoluble vegetable fibers including bamboo fiber, rice fiber, wheat fiber, oat fiber, potato fiber, nut fiber, bean fiber, and the like, or combinations thereof. In one non-limiting exemplary embodiment, the insoluble fiber may comprise bamboo fiber, rice fiber, wheat fiber, oat fiber, or combinations thereof. In another non-limiting exemplary embodiment, the insoluble fiber is bamboo fiber.

In some embodiments, the insoluble fiber may be present in the disclosed plant-based cheese-style compositions in an amount ranging from about 0.1 wt % to about 10 wt %; from about 0.25 wt % to about 7.5 wt %; from about 0.5 wt % to about 5.0 wt %; from about 1.0 wt % to about 4.5 wt %; from about 1.5 wt % to about 4.5 wt %; from about 2.0 wt % to about 4.0 wt %; from about 2.5 wt % to about 3.5 wt %; from about 2.0 wt % to about 3.0 wt %; or from about 3.0 wt % to about 4.0 wt % of the plant-based cheese-style composition. In one non-limiting exemplary embodiment, the insoluble fiber comprises bamboo fiber in an amount of about 3.0 wt % of the plant-based cheese-style composition.

In some embodiments, the insoluble fiber may comprise an average fiber length ranging from about 30 μm to about 200 μm; from about 60 μm to about 160 μm; from about 80 μm to about 150 μm; from about 100 μm to about 150 μm; from about 120 μm to about 150 μm; from about 135 μm to about 145 μm; from about 100 μm to about 140 μm; from about 100 μm to about 120 μm; or from about 110 μm to about 120 μm. In one non-limiting exemplary embodiment, the insoluble fiber comprises an average fiber length of about 115 μm. In another non-limiting exemplary embodiment, the insoluble fiber comprises an average fiber length no greater than about 145 μm.

In some embodiments, the insoluble fiber may comprise an average fiber thickness ranging from about 1 μm to about 40 μm; from about 7.5 μm to about 30 μm; from about 10 μm to about 25 μm; or from about 15 μm to about 25 μm. In one non-limiting exemplary embodiment, the insoluble fiber comprises an average fiber thickness of about 20 μm. In another non-limiting exemplary embodiment, the insoluble fiber comprises an average fiber thickness no greater than about 20 μm.

### B. Starches

The use of starches in the plant-based cheese-style compositions and products of the present invention may provide melting, viscosity, firmness, and/or emulsification properties. Starches may also contribute to structural integrity, shreddability, and dicing of plant-based cheese-style compositions and products following refrigeration. In various embodiments of the present invention, starches may include one or more of a potato starch, tapioca starch, corn starch, rice starch, wheat starch, and the like, or combinations thereof. In some embodiments, the starches may include modified starches, unmodified starches, or a combination thereof. For example, the starches may be chemically, enzymatically, or physically modified, which may involve cross-linking, substitution, dextrinization, oxidation, acid treatment, and/or heat treatment.

As used herein, an “emulsifying starch” refers to a vegetable starch that provides increased stabilization and integration of a plant-based cheese-style composition or formulation having certain ingredients that are immiscible, such as oil and water. For instance, an emulsifying starch can help prevent the coalescence of oil droplets, resulting in a smooth, creamy mixture composition. An emulsifying starch also provides better fat and moisture control and therefore can contribute to freeze-thaw stability. One non-limiting example of an emulsifying starch in the present invention includes a potato starch having emulsifying properties.

As used herein, a “viscosifying starch” or “gelling starch” refers to a vegetable starch that provides increased gelling or viscosity of a plant-based cheese-style composition or formulation. One non-limiting example of a viscosifying or gelling starch in the present invention includes a potato starch and potato protein blend having enhanced gelling and viscosity properties. The viscosifying or gelling starch provides firmness in plant-based cheese-style compositions and products following refrigeration.

In various embodiments, the disclosed plant-based cheese-style compositions may comprise one or more starches comprising one or more emulsifying starches, one or more viscosifying starches, or a combination thereof. In one non-limiting exemplary embodiment, the one or more starches may comprise an emulsifying potato starch and a viscosifying potato starch and potato protein blend.

In some embodiments, the one or more starches may be present in a total amount ranging from about 2 wt % to about 40 wt % of the plant-based cheese-style composition. In one embodiment, the one or more emulsifying starches may be present in an amount ranging from about 2 wt % to about 10 wt % of the plant-based cheese-style composition. In another embodiment, the one or more emulsifying starches may be present in an amount ranging from about 3.5 wt % to about 9 wt % of the plant-based cheese-style composition. In one embodiment, the one or more viscosifying starches may be present in an amount ranging from about 5 wt % to about 30 wt % of the plant-based cheese-style composition. In another embodiment, the one or more viscosifying starches may be present in an amount ranging from about 9.5 wt % to about 22 wt % of the plant-based cheese-style composition. In one non-limiting exemplary embodiment, the one or more starches may comprise one or more emulsifying starches in an amount ranging from about 3.5 wt % to about 9 wt % of the plant-based cheese-style composition and one or more viscosifying starches in an amount ranging from about 9.5 wt % to about 22 wt % of the plant-based cheese-style composition.

### C. Oils

The use of oils in the plant-based cheese-style compositions and products of the present invention may provide improved meltability, mouthfeel, and flavor. Oils may also contribute to structural integrity, shreddability, and dicing of plant-based cheese-style compositions and products following refrigeration. Suitable oils (or lecithins) may be obtained from sources including vegetables, seeds, nuts, and algae. Non-limiting examples of oils include coconut oil, sunflower oil, rapeseed oil, canola oil, cotton seed oil, peanut oil, olive oil, moringa oil, algal oil, safflower oil, corn oil, rice bran oil, sesame oil, hazelnut oil, avocado oil, almond oil, walnut oil, or combinations thereof.

In some embodiments, the disclosed plant-based cheese-style compositions may comprise one or more oils comprising coconut oil, sunflower oil, non-GMO canola oil, or combinations thereof. Coconut oil may be combined with soft oils such as sunflower oil and non-GMO canola oil depending on the desired body, texture, and melting properties of the plant-based cheese-style composition, as well as the process that is applied and the specific equipment that is used.

In some embodiments, the one or more oils may be present in an amount ranging from about 10 wt % to about 30 wt %; about 12 wt % to about 28 wt %; about 15 wt % to about 25 wt %; about 18 wt % to about 25 wt %; or about 15 wt % to about 21 wt % of the plant-based cheese-style composition.

### D. Vegan Cultured Bases

The use of a plant-based (i.e., vegan) cultured base in the plant-based cheese-style compositions and products of the present invention may provide for improved flavor, texture, and melt properties that are similar to a dairy-type cheese.

Non-limiting example vegan cultured bases may include one or more bacterial cultures, soluble fibers (e.g., corn fiber, pectin), sugars (e.g., dextrose and/or sucrose), plant proteins (e.g., pea protein, bean protein, potato protein), oils (e.g., sunflower oil, non-GMO canola oil, coconut oil), starches (e.g., modified tapioca starch, potato starch), and buffers (e.g., tripotassium phosphate, sodium phosphate) in a water-based formulation. The sugars provide feed for the bacterial cultures; the plant proteins, oils, sugars, and other carbohydrates provide breakdown during fermentation for texture, mouthfeel, and flavor; the soluble fibers provide a fiber source and gelling and thickening of the cultured base; and the buffers protect proteins from denaturation in the cultured base during heating.

In some embodiments, the vegan cultured base may comprise one or more bacterial strains comprising Streptococcus thermophilus, Lactobacillus delbrueckii subsp. bulgaricus, Lactobacillus delbrueckii subsp. lactis, Bifidobacterium lactis, Lactobacillus acidophilus, Lactobacillus paracasei, Lactobacillus casei, or combinations thereof. In various embodiments, the one or more bacterial strains may be present in an amount ranging from about 0.0050 wt % to about 0.02 wt % of the vegan cultured base. In one non-limiting exemplary embodiment, the one or more bacterial strains are present in an amount of about 0.011 wt % of the vegan cultured base.

In some embodiments, the vegan cultured base may be present in an amount ranging from about 15 wt % to about 30 wt %; about 17 wt % to about 30 wt %; about 19 wt % to about 30 wt %; about 20 wt % to about 30 wt %; about 15 wt % to about 25 wt %; about 15 wt % to about 20 wt %; or about 20 wt % to about 25 wt % of the plant-based cheese-style composition.

In some embodiments, the vegan cultured base may comprise a fat content ranging from about 1.80% to about 2.20%. Preferably, the vegan cultured base comprises a fat content of about 2.04%. In some embodiments, the vegan cultured base may comprise a solids content ranging from about 16% to about 18%. Preferably, the vegan cultured base comprises a solids content of about 17.2%. In some embodiments, the vegan cultured base may comprise a moisture content ranging from about 82% to about 84%. Preferably, the vegan cultured base comprises a moisture content of about 82.8%. In some embodiments, the vegan cultured base may comprise a pH before fermentation ranging from about 6.50 to about 7.20. Preferably, the vegan cultured base comprises a pH before fermentation of about 6.95. In some embodiments, the vegan cultured base may comprise a pH after fermentation and cooling ranging from about 4.30 to about 4.70. Preferably, the vegan cultured base comprises a pH after fermentation and cooling of about 4.50. In some embodiments, fermentation time of the vegan cultured base ranges from about 6 hours to about 8 hours.

### E. Additional Ingredients

In some embodiments, plant-based cheese-style compositions and products of the present invention may comprise one or more additional ingredients including one or more gums, flavoring agents, plant proteins, lecithins, preservatives, calcium-containing agents, coloring agents, pH-modifying agents, anti-caking agents, film formers, salts, sugars, or combinations thereof.

The use of gums may contribute to structural integrity, shreddability, and dicing of plant-based cheese-style compositions and products following refrigeration. Non-limiting examples of suitable gums include xanthan gum, gellan gum, locust bean gum, guar gum, karaya gum, gum Arabic, Konjac gum, and the like, or combinations thereof. In one embodiment, xanthan gum may provide viscosity, body, and emulsifying properties to the plant-based cheese-style composition; gellan gum (low acyl) may provide firmness and gelling properties for shreddability, and stabilizing and water holding properties for freeze-thaw stability; and Konjac gum may provide thickening and gelling properties contributing to stretch, water holding property for freeze-thaw stability, and firmness for shreddability. In another embodiment, gellan gum (low acyl type) may provide firmness and some degree of brittleness, while also providing gelling, texturizing, stabilizing, film-forming, and water-holding properties. In another embodiment, Konjac gum may act as a thickening and gelling agent to provide thermo-reversible, elastic gels and thus contribute to stretch and water-holding. In another embodiment, gellan gum (low acyl) may be used to provide firmness for efficient dicing, and the amount of viscosifying starch, if included in the formulation, may be reduced.

In some embodiments, plant-based cheese-style compositions may comprise one or more gums comprising gellan gum, Konjac gum, xanthan gum, or combinations thereof. Gellan gum and/or Konjac gum together with insoluble fiber contribute to overall mouthfeel, reduced stickiness, and improved chewiness.

In some embodiments, the one or more gums may be present in a total amount ranging from about 0.1 wt % to about 2 wt % of the plant-based cheese-style composition. In one embodiment, gellan gum may be present in an amount ranging from about 0.1 wt % to about 1.0 wt % of the plant-based cheese-style composition. In another embodiment, Konjac gum may be present in an amount ranging from about 0.1 wt % to about 1.0 wt % of the plant-based cheese-style composition. In one non-limiting exemplary embodiment, the one or more gums may comprise gellan gum in an amount ranging from about 0.1 wt % to about 0.3 wt % of the plant-based cheese-style composition and Konjac gum in an amount ranging from about 0.1 wt % to about 0.3 wt % of the plant-based cheese-style composition.

Non-limiting examples of pH-modifying agents include tripotassium phosphate and citric acid. Non-limiting examples of suitable plant proteins include pea protein, faba bean protein, and potato protein. Non-limiting examples of preservatives include potassium sorbate. Non-limiting examples of calcium-containing agents include tricalcium phosphate, which may also provide an opacifying/coloring effect. Non-limiting examples of coloring agents include beta-carotene. Non-limiting examples of sugars include dextrose. Non-limiting examples of anti-caking agents include cellulose gel and potassium salt flour. Non-limiting examples of film formers include hydroxypropyl methylcellulose (HPMC), which is an oil binding film former that serves as a barrier to fat and moisture migration and contributes to structural integrity. In particular, methylcellulose creates a strong film upon frying that becomes a barrier to reduce fat uptake and moisture loss during frying of the disclosed compositions, while also enhancing the crispiness of the final product both out of the fryer and after reheating or baking. An exemplary HPMC has medium viscosity (4000 cP at 2% solution) and optimal hydration at <25° C., and forms a semi-firm gel at 58-64° C.

### 3. Methods of Making Plant-Based Cheese-Style Compositions

Described herein are methods of making plant-based cheese-style compositions and products. The disclosed methods may comprise various techniques and equipment including indirect and/or direct heat processing using a high shear mixer or a single or twin-screw cooker.

The methods may comprise mixing a vegan cultured base with heated water to create a base mixture; shear mixing one or more oils with the base mixture to create a dispersion of particles; shear mixing an insoluble fiber with the dispersion of particles to create a fiber mixture; heating the fiber mixture; shear mixing one or more starches/protein blend with the heated fiber mixture to create a blend; heating the blend; and refrigerating the heated blend to create the plant-based cheese-style composition.

The methods may further comprise mixing one or more gums, flavoring agents, plant proteins, lecithins, preservatives, calcium-containing agents, coloring agents, pH-modifying agents, anti-caking agents, film formers, salts, sugars, or combinations thereof to the heated water, base mixture, dispersion of particles, fiber mixture, blend, plant-based cheese-style composition, or combinations thereof. The methods may also further comprise one or more additional heating steps. The methods may also further comprise performing one or more additional processing steps to the plant-based cheese-style composition comprising cutting, shredding, dicing, crumbling, shaping, slicing, freezing, preserving, storing, packaging, or combinations thereof.

In some embodiments, one or more of the pH, solids content, or moisture content of the heated blend may be adjusted prior to refrigerating. In other embodiments, the heated blend may be provided to a mold or container prior to refrigerating. In other embodiments, the insoluble fiber may be pre-blended with other dry ingredients prior to shear mixing with the dispersion of particles. In other embodiments, the one or more oils may be pre-heated to a temperature ranging from about 40° C. to about 60° C. prior to shear mixing with the base mixture. In one non-limiting exemplary embodiment, the one or more oils is pre-heated to a temperature ranging from about 46° C. to about 49° C. prior to shear mixing with the base mixture.

In some embodiments, the heated water comprises a temperature ranging from about 50° C. to about 70° C. In one non-limiting exemplary embodiment, the heated water comprises a temperature ranging from about 62° C. to about 66° C.

In some embodiments, heating comprises a temperature ranging from about 55° C. to about 95° C. In some embodiments, refrigerating comprises a temperature ranging from about 2° C. to about 7° C.

In some embodiments, shear mixing comprises a shear speed ranging between about 2,000 rpm to about 12,000 rpm or ranging between about 33 Hz to about 200 Hz.

### 4. EXPERIMENTAL EXAMPLES

### Example 1

### Plant-Based Vegan Cultured Base

Bench top processing. First, in a double boiler, water was heated to 135-140° F. (57.2-60.0° C.). Then, pectin and tripotassium phosphate were added and blended for 5 minutes or until pectin was well-dispersed and hydrated using a Silverson (Model L5M-A) high shear laboratory mixer at 5000-5500 rpm. Using a Silverson blade with bigger holes allowed for easier dispersion of the particles. The speed was then increased to about 8000-8500 rpm and the pre-blended proteins, dextrose, soluble corn fiber, and starch were then added. Blending was then performed for 5 minutes or until the particles were well dispersed, maintaining the temperature at 125-135° F. (51.7-57.2° C.). Pre-warmed sunflower oil (115-120 CF or 46-49° C.) was added and blended for 5 minutes. The pH was checked and recorded (expected pH=6.85-7.15). To avoid too much foaming, mixing was continued, and the proteins were hydrated for 10 minutes using a Stir-Pak Laboratory Mixer (Model 04555-00 with either a propeller or radial type agitator blade applying speed #3-4 or about 2000-3000 rpm), and maintaining temperature at 130-135° F. (54.4-57.2° C.) during agitation. Mixing was continued for 5 minutes while increasing the temperature to 130-140° F. (54.4-60° C.)—it takes about 5 minutes to heat up to this temperature. Homogenization was performed at 2500 psi or 173 bar (2000 1st stage/500 2nd stage or 138 bar 1st stage/35 bar 2nd stage). Pasteurization was then performed at 185-190° F. (85-88° C.) for 10-15 minutes, with continuous gentle agitation using the Stir-Pak Laboratory Mixer at speed #3-4. The samples were collected into sanitized stainless-steel containers and cooled to about 112° F. (44.4° C.) by immersing the container in cold water (about 41-50° F. or 5-10° C.). When the temperature of the mix was about 112° F. (44.4° C.), about 50-100 mL of the warm base was placed in a sterile screw-capped plastic cup. The freeze-dried cultures were mixed by shaking gently until all particles were dispersed. The mix was then poured into the rest of the base and blended for 10-15 minutes using the Stir-Pak Laboratory Mixer at speed #3-4 (the spindle was sanitized before use). The cultured base was then incubated at 108-112° F. (42.2-44.4° C.) for about 6-8 hours or until the pH was about 4.3-4.7. The white mass was agitated and smoothened. The cultured base was then ready for use in plant-based cheese alternatives. If the base was stored before use, it was cooled down to about 40° F. (4.4° C.) with gentle agitation by either using a sanitized plastic spatula or the Stir-Pak Laboratory Mixer with a sanitized agitator. The container may be immersed in iced water for quicker cooling. Mixing speeds indicated above may be adjusted as needed depending on the amount of the batch. An example plant-based (vegan) cultured base formulation is shown in Table 1.

TABLE 1
Example plant-based (vegan) cultured base formulation
used in plant-based cheese alternative compositions.

| Ingredient | wt % |
|---|---|
| Water | 81.517 |
| Soluble Corn Fiber | 4.444 |
| Dextrose | 4.200 |
| Pea Protein | 3.891 |
| Faba Bean Protein | 2.223 |
| Sunflower Oil | 1.667 |
| Modified Tapioca Starch | 1.667 |
| Pectin | 0.280 |
| Tripotassium Phosphate | 0.111 |
| TOTAL | 100.000 |
| Bacterial Cultures | 0.011% (total cultures) of the formulation |

The disclosed vegan cultured bases include one or more bacterial strains comprising Streptococcus thermophilus, Lactobacillus delbrueckii subsp. bulgaricus, Lactobacillus delbrueckii subsp. lactis, Bifidobacterium lactis, Lactobacillus acidophilus, Lactobacillus paracasei, Lactobacillus casei, or combinations thereof. Examples of different bacterial strain combinations that may be used in vegan cultured bases are provided in Table 2.

TABLE 2
Example bacterial strain culture combinations
used in vegan cultured bases.

| | Usage rate |
|---|---|
| | (%) |
| Example Culture 1 | |
| Streptococcus thermophilus | 0.011% |
| Lactobacillus delbrueckii subsp. bulgaricus | |
| Example Culture 2 | |
| Streptococcus thermophilus | 0.0055% |
| Lactobacillus delbrueckii subsp. bulgaricus | |
| Streptococcus thermophilus | 0.0055% |
| Lactobacillus delbrueckii subsp. bulgaricus | |
| Lactobacillus delbrueckii subsp. lactis | |
| Bifidobacterium lactis | |
| Lactobacillus acidophilus | |
| Example Culture 3 | |
| Streptococcus thermophilus | 0.0055% |
| Lactobacillus delbrueckii subsp. bulgaricus | |
| Streptococcus thermophilus | 0.0055% |
| Lactobacillus delbrueckii subsp. bulgaricus | |
| Lactobacillus paracasei and/or | |
| Lactobacillus casei | |
| Lactobacillus acidophilus | |
| Bifidobacterium lactis | |

Pilot lab processing. First, in a tank with high shear mixing capability, e.g., a Likwifier/Liquifier or a Rotosolver, the water was heated to 135-140° F. (57.2-60.0° C.). Then the pectin and tripotassium phosphate were added and blended for 5 minutes or until the pectin was well dispersed and hydrated (26-28 Hz or 1560-1680 rpm). The pre-blended proteins, dextrose, soluble corn fiber, and starch were added (5 minutes, 28 Hz or 1680 rpm). Then the pre-warmed sunflower oil (115-120° F. or 46-49° C.) was added and blended for 5 minutes. The pH was checked and recorded (expected pH=6.85-7.15). The mix was then transferred to a batch tank with a scrape surface agitator (when Rotosolver was used as high shear mixer) and the proteins were continuously hydrated for 10-15 minutes while increasing the temperature to 185-190° F. (85-88° C.). Homogenization was performed at 2500 psi or 173 bar (2000 1st stage/500 2nd stage or 138 bar 1st stage/35 bar 2nd stage) and then cooling to about 112° F. (44.4° C.) through plate heat exchangers. The collected amount of the mix was weighed and transferred into a fermentation tank and about 50-100 ml of the warm base was placed in a sterile screw-capped plastic cup. The amount of product collected for culture mixing may vary depending on the total volume of the mix and the amount of cultures needed. The freeze-dried cultures were mixed in by shaking the plastic cup gently until all particles were dispersed. The mix was then poured into the rest of the product in the fermentation tank and blended for 15-30 minutes. The agitation was stopped and the mix was incubated at 108-112° F. (42.2-44.4° C.) for about 6-8 hours or until the pH was about 4.3-4.7. The incubation time starts after pouring the blended culture and product into the rest of the product in the fermentation tank. The white mass was agitated and smoothened. The cultured base was then ready for use in plant-based cheese alternatives. If the base was stored before use, it was cooled down to about 36-40° F. (2.2-4.4° C.) using chilled water. The base was then collected in clean, sanitized containers and the weight of the collected product was recorded before storing at 36-40° F. (2.2-4.4° C.).

Plant scale-up processing. First, in a tank with high shear mixing capability, e.g. a Liquifier, the water was heated to 135-140° F. (57.2-60.0° C.). The Liquifier or mixing unit may be connected to a batching tank to recirculate the product during the addition of ingredients to provide for a more efficient mixing. Then the pectin and tripotassium phosphate were added, followed by adding the proteins, dextrose, soluble corn fiber, starch, and the pre-warmed sunflower oil (115-120° F. or 46-49° C.). The pH was checked and recorded (expected pH=6.85-7.15). The proteins were continuously hydrated for 5-10 minutes at about 57.2° C., by applying gentler speeds. The temperature was then increased to 140-145° F. (60-62.8° C.) and the mix was transferred into a batching tank. Homogenization was performed at 2500 psi or 173 bar (2000 1st stage/500 2nd stage or 138 bar 1st stage/35 bar 2nd stage). Heating (190-195° F. or 88-91° C., 15 seconds) and cooling (112° F. or 44.4° C.) of the product were then performed through plate heat exchangers. The product was then transferred into the holding or fermentation tank and the weight was recorded. About 1-2 liters of the product was collected and added to the freeze-dried cultures and blended for 15-30 minutes until the particles were well dispersed. Clean and sanitized containers and agitators were used. The blended product and cultures were poured into the rest of the product in the fermentation tank and agitated for 30 minutes while avoiding excessive foaming. The agitation was stopped, and the mix was incubated at 108-112° F. (42.2-44.4° C.) for about 6-8 hours or until the pH was about 4.3-4.7. The incubation time starts after pouring the blended culture and product into the rest of the product in the fermentation tank. The white mass was agitated and smoothened once the desired pH was reached. The cultured base was then ready for use in plant-based cheese alternatives. If the base was stored before use, it was cooled down to about 36-40° F. (2.2-4.4° C.) and applying gentle agitation. Depending on the volume, batch cooling may take a few hours. It is recommended to stop incubation and start cooling at pH 4.7-4.8 since acid formation may still take place during the slow cooling thereby decreasing the pH further. The base was then collected in clean, sanitized containers and the weight of the collected product was recorded before storing at 36-40° F. (2.2-4.4° C.).

A summary of the physical and chemical characteristics of an example vegan cultured base are provided in Table 3.

TABLE 3
Physical and chemical characteristics
of an example vegan cultured base.

| | Specification |
|---|---|
| Physical analysis | |
| Appearance | Yogurt-like gel and consistency |
| | when stirred and cooled |
| Color | Yellowish cream |
| Aroma | Fermented, sour |
| Flavor | Fermented, sour notes |
| Texture | Smooth to matte gel; smooth and shiny |
| | yogurt-like texture when stirred and cooled |
| Chemical analysis | |
| Fat (%) | 1.89-2.19 (target = 2.04) |
| Total Solids (%) | 16.7-17.7 (target = 17.2) |
| Moisture (%) | 82.3-83.3 (target = 82.8) |
| pH of emulsion before | 6.80-7.15 (target = 6.95) |
| fermentation | |
| pH of product after | 4.3-4.7 (target = 4.5) |
| fermentation and cooling | |
| Fermentation Period | 6-8 hours |

### Example 2

### Plant-Based Mozzarella Cheese-Style Shreds

Bench top processing. First, in a double boiler, water was heated to 145-150° F. (62.8-65.6° C.) using a hot plate. Then, the vegan cultured base, tricalcium phosphate, and color were added with continuous gentle stirring for 1-2 minutes using a Stir-Pak Laboratory Mixer (Model 04555-00 with either a propeller or radial type agitator blade applying speed #3-4 or about 2000-3000 rpm) and the temperature maintained at 145-150° F. (62.8-65.6° C.) during agitation. The pre-warmed coconut oil (115-120° F.; 46.1-48.9° C.), citric acid, and flavors were then added and blended for 1-2 minutes using a Silverson (Model L5M-A) high shear laboratory mixer at 5000-5500 rpm. Use of a Silverson mixing head blade with bigger holes allows for easier dispersion of the particles. Bamboo fiber was then added and blended using the Silverson mixer for 2 minutes at 7000-7500 rpm and the mix was heated to 185-190° F. (85-87.8° C.) on a hot plate. Using the Silverson mixer, the speed was set to about 9000-10000 rpm, and the pre-blended potato starch/potato protein, gums, potassium sorbate, and salt were added and blended for 4-5 minutes or until the particles were well dispersed. The blend was then heated for 4-6 minutes at 176-185° F. (80-85° C.) and the pH and total solids/moisture content were tested and adjusted as needed. The blend was then poured into non-stick cheese molds or pans and refrigerated (36-43° F.; 2.2-6.1° C.) until set. An example plant-based mozzarella cheese-style shred composition is shown in Table 4.

TABLE 4
Example plant-based mozzarella cheese-style shred composition.

| Ingredient | wt % | wt % range |
|---|---|---|
| Emulsifying Potato Starch | 8.9347 | 4.0-9.0 |
| Viscosifying Potato Starch | 15.0000 | 12.0-20.0 |
| and Potato Protein | | |
| Water | 30.8110 | 27-33 |
| Vegan Cultured Base | 19.3734 | 19-25 |
| Coconut Oil | 19.0314 | 18-21 |
| Insoluble Bamboo Fiber | 3.0000 | 1.5-4.5 |
| Salt | 1.7000 | 1.5-2.0 |
| Natural Flavor(s) | 0.2800 | 0.24-0.42 |
| Tricalcium Phosphate (TCP) | 1.0000 | 0.70-1.25 |
| Gellan Gum | 0.2900 | 0.1-0.3 |
| Konjac Gum | 0.2900 | 0.1-0.3 |
| Xanthan Gum | 0.000 | 0.00-0.19 |
| Citric Acid | 0.0800 | 0.05-0.125 |
| Potassium Sorbate | 0.2000 | 0.1-0.3 |
| (Preservative) | | |
| Beta-carotene (color) | 0.0095 | 0.000-0.012 |
| TOTAL | 100.000 | |

Pilot lab processing (high shear mixing with indirect heating). First, in a high shear mixer (e.g., Liquifier) with a surface scraper, water was heated to 135-140° F. (57.2-60° C.). Preservative was added and blended for 1 minute (scrape speed=40-45 Hz; shear speed=6 Hz). Then the cultured base, tricalcium phosphate, and color, were added while maintaining temperature at 135-140° F. (57.2-60° C.) and blended for 1 minute. The pre-warmed coconut oil (115-120° F.; 46.1-48.9° C.), citric acid, and flavors were added and blended for 2 minutes and the temperature was set to 155-165° F. (68.3-73.9° C.) (scrape speed=60 Hz; shear speed=15 Hz) before bamboo fiber, starches/potato protein, gums, and salt were added. The temperature was increased to 176-185° F. (80-85° C.) (scrape speed=60 Hz; shear speed=24-27 Hz) and held for 6-8 minutes. The pH and total solids/moisture content were tested and adjusted as needed. The mixture was then added into clean, dry stainless-steel pans lined with clean heat-resistant plastic bags and placed in a cooler (36-43° F.: 2.2-6.1° C.) to harden for 5 days or until the final product was set. The product was then cut into smaller blocks and shredded. The shreds were MAP packaged (70% nitrogen/30% carbon dioxide) and refrigerated (36-43° F.; 2.2-6.1° C.). The scrape and shear speeds indicated above may be adjusted as needed depending on the amount of the batch.

Pilot lab processing (single or twin-screw cooker with direct and indirect heating). First, water was poured into the cooker. Reduce water by 50-65% due to steam condensate during direct steam injection. The cooker was set at 135-140° F. (57.2-60° C.) by applying indirect heat and speed at 96-120 rpm. The preservative was added and blended for 1 minute. Then, the cultured base, tricalcium phosphate, and color were added while maintaining temperature at 135-140° F. (57.2-60° C.) by applying indirect heat and blended for 1 minute. The pre-warmed coconut oil (115-120° F.; 46.1-48.9° C.), citric acid, and flavors were added and blended for 2 minutes. The indirect heat was then turned off and pre-blended bamboo fiber, starches/potato protein, gums, and salt were added. Direct steam injection heat was then applied to 176-185° F. (80-85° C.), maintaining this temperature for 8-10 minutes at 140 rpm. The pH and total solids/moisture content were tested and adjusted as needed. The mixture was then added into clean, dry stainless-steel pans lined with clean heat-resistant plastic bags and placed in a cooler (36-43° F.; 2.2-6.1° C.) to harden for 5 days or until the final product was set. The product was then cut into smaller blocks and shredded. The shreds were MAP packaged (70% nitrogen/30% carbon dioxide) and refrigerated (36-43° F.; 2.2-6.1° C.). If preferred, direct heating may be applied (instead of indirect heating) throughout the entire process.

Plant scale-up processing (twin-screw cooker with direct heating)—Option 1. First, water was scaled into the twin screw cooker. Reduce water as needed due to steam condensate during direct steam injection. Then, the cultured base, preservative, TCP, and color were added and the cooker was set to a temperature of 135-140° F. (57.2-60° C.) by applying direct steam injection and speed at 80 rpm, and blending was performed for 1 minute. The pre-heated coconut oil (120-130° F.; 48.8-54.5° C.), citric acid, and flavors were added and heated to 165-170° F. (73.8-76.7° C.) for 2 minutes at 160 rpm. Then, the pre-blended bamboo fiber, starches/potato protein, gums, and salt were added and heated to 185° F. (85° C.) at 160 rpm and then blended for 5 minutes when the temperature was reached, which took about 5 minutes. A sample was tested for moisture, salt, fat, and pH and these parameters were adjusted as needed. The temperature was continuously maintained at 185° F. (85° C.) and blended for 10 minutes at 160 rpm. The batch was then dropped for filling in a 20 lb bag in a case, where the overfill was not to exceed 20.1 lb. Samples for microbiological testing were also collected per batch. The case was then sealed, palletized, and refrigerated at 36-40° F. (2.2-4.4° C.). Full and/or partial pallets were taken to refrigerators immediately after completion with no longer than 15 minutes sitting idle. The products were held a minimum of 10 days prior to shredding the blocks. About 1% anticaking agent (cellulose gel with natamycin) was then added before the shreds were MAP packaged (70% nitrogen/30% carbon dioxide) and the products were refrigerated (36-40° F.; 2.2-4.4° C.).

Plant scale-up processing (twin-screw cooker with direct heating)—Option 2. First, oils were pre-heated to 120-130° F. (48.8-54.5° C.) to melt prior to batching, and then scaled into a twin screw cooker. Emulsifying starch was added and blended for 2 minutes at 80 rpm. Then, water, cultured base, preservative, TCP, color, citric acid, and flavors were added and heated to 165-170° F. (73.8-76.7° C.) for 2 minutes at 160 rpm. Reduce water as needed due to steam condensate during direct steam injection. Then, the pre-blended bamboo fiber, starches/potato protein, gums, and salt were added and heated to 185° F. (85° C.) at 160 rpm and then blended for 5 minutes when the temperature was reached, which took about 5 minutes. A sample was tested for moisture, salt, fat, and pH and these parameters were adjusted as needed. The temperature was continuously maintained at 185° F. (85° C.) and blended for 10 minutes at 160 rpm. The batch was then dropped for filling in a 20 lb bag in a case, where the overfill was not to exceed 20.1 lb. Samples for microbiological testing were also collected per batch. The case was then sealed, palletized, and refrigerated at 36-40° F. (2.2-4.4° C.). Full and/or partial pallets were taken to refrigerators immediately after completion with no longer than 15 minutes sitting idle. The products were held a minimum of 10 days prior to shredding the blocks. About 1% anticaking agent (cellulose gel with natamycin) was then added before the shreds were MAP packaged (70% nitrogen/30% carbon dioxide) and the products were refrigerated (36-40° F.; 2.2-4.4° C.).

A summary of the chemical characteristics of example plant-based mozzarella cheese-style block and shred compositions is provided in Table 5.

TABLE 5
Chemical characteristics of example plant-based mozzarella
cheese-style block and shred compositions.

| | Specification |
|---|---|
| Mozzarella Cheese-Style Blocks | |
| Fat (%) | 19.1-20.1 (Target = 19.6) |
| Total Solids (%) | 52.3-54.3 (Target = 53.3) |
| Moisture (%) | 45.7-47.7 (Target = 46.7) |
| pH immediately after batching | 4.51-4.71 (Target = 4.61) |
| (measured at 40-44° C.) | |
| pH of refrigerated block | 4.60-4.95 |
| Mozzarella Cheese-Style Shreds | |
| Fat (%) | 18.9-19.9 (Target = 19.4) |
| Total Solids (%) | 53.3-55.3 (Target = 54.3) |
| Moisture (%) | 45.7-47.7 (Target = 46.7) |
| pH of finished product | 4.60-4.95 |

Experiments were performed to examine the different textural properties between an exemplary plant-based mozzarella cheese-style shred composition having no fiber to a plant-based mozzarella cheese-style shred composition including insoluble fiber (3 wt % bamboo fiber). The different shred formulations tested are shown in Table 6.

TABLE 6
Example plant-based mozzarella cheese-style shred
compositions with and without insoluble fiber.

| | | 3.0% |
|---|---|---|
| | No Fiber | Bamboo Fiber |
| Ingredient | wt % | wt % |
| Emulsifying Potato Starch | 8.9347 | 8.9347 |
| Viscosifying Potato Starch | 13.0000 | 13.0000 |
| and Potato Protein | | |
| Water | 36.0056 | 33.0056 |
| Vegan Cultured Base | 19.3734 | 19.3734 |
| Coconut Oil | 19.0314 | 19.0314 |
| Insoluble Bamboo Fiber | 0 | 3.0000 |
| Salt | 1.7054 | 1.7054 |
| Natural Flavors | 0.4000 | 0.4000 |
| Tricalcium Phosphate (TCP) | 1.0000 | 1.0000 |
| Konjac Gum | 0.2900 | 0.2900 |
| Citric Acid | 0.1500 | 0.1500 |
| Potassium Sorbate | 0.1000 | 0.1000 |
| (Preservative) | | |
| Beta-carotene (color) | 0.0095 | 0.0095 |
| TOTAL | 100.000 | 100.000 |

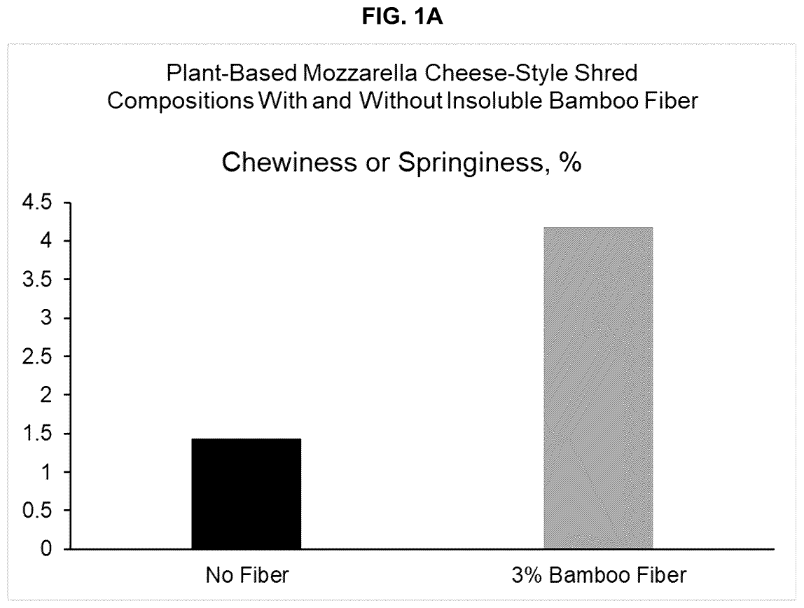

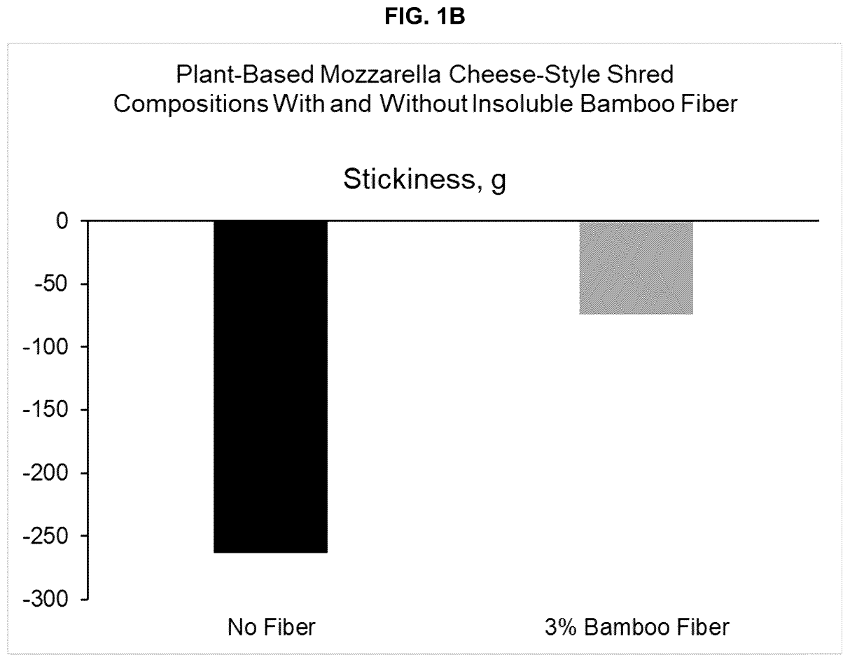

The plant-based mozzarella cheese-style shred composition having 3 wt % insoluble bamboo fiber exhibited nearly 3× the level of chewiness/springiness as compared to the shred composition having no fiber (FIG. 1A). Further, the plant-based mozzarella cheese-style shred composition having 3 wt % insoluble bamboo fiber also exhibited a significantly lower level of stickiness as compared to the shred composition having no fiber (FIG. 1B). These results indicated that the inclusion of insoluble fiber improves the overall textural properties of the disclosed plant-based mozzarella cheese-style shred compositions.

### Example 3

### Plant-Based Mozzarella Cheese-Style Sticks

Bench top processing. First, in a double boiler, water was heated to 145-150° F. (62.7-65.6° C.) using a hot plate. Then, the vegan cultured base, tricalcium phosphate, tripotassium phosphate, and color were added with continuous gentle stirring for 1-2 minutes using a Stir-Pak Laboratory Mixer (Model 04555-00 with either a propeller or radial type agitator blade applying speed #3-4 or about 2000-3000 rpm) and the temperature maintained at 145-150° F. (62.7-65.6° C.) during agitation. Sunflower lecithin was then added to pre-warmed coconut oil (115-120° F.; 46.1-48.9° C.), which was added to the mix along with flavors and then blended for 1-2 minutes using a Silverson (Model L5M-A) high shear laboratory mixer at 5000-5500 rpm. Use of a Silverson mixing head blade with bigger holes allows for easier dispersion of the particles. Bamboo fiber was then added and blended using the Silverson mixer for 2 minutes at 7000-7500 rpm and the mix was heated to 185-190° F. (85-87.8° C.) on a hot plate. Using the Silverson mixer, the speed was set to about 9000-10000 rpm, and the pre-blended potato starch, potato protein, HPMC, gums, potassium sorbate, and salt were added and blended for 4-5 minutes or until the particles were well dispersed. The blend was then heated for 4-6 minutes at 176-185° F. (80-85° C.) and the pH and total solids/moisture content were tested and adjusted as needed. The blend was then poured into non-stick cheese molds or pans and refrigerated (36-43° F.; 2.2-6.1° C.) until set. An example plant-based mozzarella cheese-style stick composition is shown in Table 7.

TABLE 7
Example plant-based mozzarella cheese-style stick composition.

| Ingredient | wt % | wt % range |
|---|---|---|
| Water | 34.8866 | 31.5-37.5 |
| Viscosifying Potato Starch and | 21.7234 | 16-22 |
| Potato Protein | | |
| Insoluble Bamboo Fiber | 3.0000 | 1.5-4.5 |
| Vegan Cultured Base | 17.0506 | 17-20 |
| Coconut Oil | 16.7948 | 15-19 |
| Sunflower Oil | 1.5360 | 0-3 |
| Salt | 1.4173 | 1.2-1.6 |
| Natural Flavor | 1.5350 | 1.15-1.55 |
| Tricalcium Phosphate (TCP) | 0.5900 | 0.3-1.0 |
| Hydroxypropyl | 0.4800 | 0.00-0.50 |
| Methylcellulose (HPMC) | | |
| Sunflower Lecithin | 0.2558 | 0.20-0.32 |
| Gellan Gum | 0.2558 | 0.1-0.3 |
| Konjac Gum | 0.2558 | 0.1-0.3 |
| Tripotassium Phosphate (TKP) | 0.1108 | 0.08-0.12 |
| Beta-carotene (color) | 0.0081 | 0.000-0.012 |
| Potassium Sorbate | 0.1000 | 0.1-0.3 |
| TOTAL | 100.000 | |

Pilot lab processing (high shear mixing with indirect heating). First, in a high shear mixer (e.g., Liquifier) with a surface scraper, water was heated to 135-140° F. (57.2-60° C.). Preservative was added and blended for 1 minute (scrape speed=40-45 Hz; shear speed=6 Hz). Then, the cultured base, tricalcium phosphate, tripotassium phosphate, and color, were added while maintaining temperature at 135-140° F. (57.2-60° C.) and blended for 1 minute. Sunflower lecithin was then added to pre-warmed coconut oil (115-120° F.; 46.1-48.9° C.), which was added to the mix along with flavors and then blended for 2 minutes and the temperature was set to 155-165° F. (68.3-73.9° C.) (scrape speed=60 Hz; shear speed=15 Hz) before bamboo fiber, starches/potato protein, HPMC, gums, potassium sorbate, and salt were added. The temperature was increased to 176-185° F. (80-85° C.) (scrape speed=60 Hz; shear speed=24-27 Hz) and held for 6-8 minutes. The pH and total solids/moisture content were tested and adjusted as needed. The mixture was then added into clean, dry stainless-steel pans lined with clean heat-resistant plastic bags and placed in a cooler (36-43° F.; 2.2-6.1° C.) to harden for 5 days or until the final product was set. The scrape and shear speeds indicated above may be adjusted as needed depending on the amount of the batch.

Pilot lab processing (single or twin-screw cooker with direct and indirect heating). First, water was poured into the cooker. Reduce water by 50-65% due to steam condensate during direct steam injection. The cooker was set at 135-140° F. (57.2-60° C.) by applying indirect heat and speed at 96-120 rpm. The preservative was added and blended for 1 minute. Then, the cultured base, tricalcium phosphate, tripotassium phosphate, and color were added while maintaining temperature at 135-140° F. (57.2-60° C.) by applying indirect heat and then blended for 1 minute. Sunflower lecithin was then added to pre-warmed coconut oil (115-120° F.; 46.1-48.9° C.), which was added to the mix along with flavors and then blended for 2 minutes. The indirect heat was then turned off and pre-blended bamboo fiber, starches/potato protein, HPMC, gums, and salt were added. Direct steam injection heat was then applied to 176-185° F. (80-85° C.), maintaining this temperature for 8-10 minutes at 140 rpm. The pH and total solids/moisture content were tested and adjusted as needed. The mixture was then added into clean, dry stainless-steel pans lined with clean heat-resistant plastic bags and placed in a cooler (36-43° F.; 2.2-6.1° C.) to harden for 5 days or until the final product was set. If preferred, direct heating may be applied (instead of indirect heating) throughout the entire process.

A summary of the chemical characteristics of example plant-based mozzarella cheese-style stick compositions is provided in Table 8.

TABLE 8
Chemical characteristics of example plant-based
mozzarella cheese-style stick compositions.

| Mozzarella Cheese-Style Sticks | Specification |
|---|---|
| Fat (%) | 19-21 (Target = 20) |
| Total Solids (%) | 48-52 (Target = 50) |
| Moisture (%) | 44-48 (Target = 46) |
| pH immediately after batching | 4.65-4.85 (Target = 4.75) |
| (measured at 40-44° C.) | |
| pH of refrigerated block | 4.90-5.10 (Target = 5.00) |

### Example 4

### Plant-Based Feta Cheese-Style

Bench top processing. First, in a double boiler, water was heated to 145-150° F. (62.7-65.6° C.) using a hot plate. Then, the vegan cultured base, tricalcium phosphate, and color were added with continuous gentle stirring for 1-2 minutes using a Stir-Pak Laboratory Mixer (Model 04555-00 with either a propeller or radial type agitator blade applying speed #3-4 or about 2000-3000 rpm) and the temperature maintained at 145-150° F. (62.7-65.6° C.) during agitation. The pre-warmed coconut oil (115-120° F.; 46.1-48.9° C.), citric acid, tartaric acid (increases perception of tartness, typical of dairy-based feta cheeses), and flavors were then added and blended for 1-2 minutes using a Silverson (Model L5M-A) high shear laboratory mixer at 5000-5500 rpm. Use of a Silverson mixing head blade with bigger holes allows for easier dispersion of the particles. Bamboo fiber was then added and blended using the Silverson mixer for 2 minutes at 7000-7500 rpm and the mix was heated to 185-190° F. (85-87.8° C.) on a hot plate. Using the Silverson mixer, the speed was set to about 9000-10000 rpm, and the pre-blended potato starch/potato protein and salt were added and blended for 4-5 minutes or until the particles were well dispersed. The blend was then heated for 4-6 minutes at 176-185° F. (80-85° C.) and the pH and total solids/moisture content were tested and adjusted as needed. The blend was then poured into non-stick cheese molds or pans and refrigerated (36-43° F.; 2.2-6.1° C.) for 5 days or until set. The product was then cut into smaller blocks and diced or crumbled using a food processor. The diced/crumbled plant-based cheese pieces were weighed in a clean bucket. Then, blended cellulose gel anti-caking agent and potassium salt flour mix were sprinkled to evenly coat the crumbled/diced pieces. The finished product was packaged in plastic bags, sealed, and refrigerated at 36-43° F. (2.2-6.1° C.).

An example plant-based feta cheese-style composition is shown in Table 9.

TABLE 9
Example plant-based feta cheese-style composition.

| Ingredient | wt % | wt % range |
|---|---|---|
| Vegan Cultured Base | 25.0000 | 20-25 |
| Water | 28.8247 | 26.5-32.5 |
| Coconut Oil | 20.9700 | 20-23 |
| Viscosifying Potato Starch/ | 10.5000 | 9.5-12.0 |
| Potato Protein | | |
| Emulsifying Potato Starch | 4.0555 | 3.5-5.0 |
| Insoluble Bamboo Fiber | 4.5000 | 1.5-4.5 |
| Salt | 1.5000 | 0.5-3.5 |
| Tricalcium Phosphate (TCP) | 1.0000 | 0.5-1.0 |
| Gellan Gum | 0.000 | 0.0-0.4 |
| Citric Acid | 0.2500 | 0.15-0.25 |
| Tartaric Acid | 0.1450 | 0.14-0.25 |
| Natural Flavor(s) | 1.2500 | 0.55-2.51 |
| Beta-carotene (color) | 0.0048 | 0.00-0.10 |
| TOTAL | 98.000 | |
| *Cellulose gel anti-caking agent | 2.00 | 1.0-2.0 |
| *Potassium salt flour mix | 2.00 | 1.0-2.0 |

*added to final crumbled/diced product

Pilot lab processing (high shear mixing with indirect heating). First, in a high shear mixer (e.g., Liquifier) with a surface scraper, water was heated to 135-140° F. (57.2-60° C.). Preservative was added and blended for 1 minute (scrape speed=40-45 Hz; shear speed=6 Hz). Then the cultured base, tricalcium phosphate, and color, were added while maintaining temperature at 135-140° F. (57.2-60° C.) and blended for 1 minute. The pre-warmed coconut oil (115-120° F.; 46.1-48.9° C.), citric acid, tartaric acid, and flavors were added and blended for 2 minutes and the temperature was set to 155-165° F. (68.3-73.9° C.) (scrape speed=60 Hz; shear speed=15 Hz) before bamboo fiber, starches/potato protein, and salt were added. The temperature was increased to 176-185° F. (80-85° C.) (scrape speed=60 Hz; shear speed=24-27 Hz) and held for 6-8 minutes. The pH and total solids/moisture content were tested and adjusted as needed. The mixture was then added into clean, dry stainless-steel pans lined with clean heat-resistant plastic bags and placed in a cooler (36-43° F.; 2.2-6.1° C.) to harden for 5 days or until the final product was set. The product was then cut into smaller blocks and diced using a cheese dicer. The diced plant-based cheese pieces were weighed in a clean bucket. Then, blended cellulose gel anti-caking agent and potassium salt flour mix were sprinkled to evenly coat the diced pieces. The finished product was packaged in plastic bags, sealed, and refrigerated at 36-43° F. (2.2-6.1° C.). The scrape and shear speeds indicated above may be adjusted as needed depending on the amount of the batch.

Pilot lab processing (single or twin-screw cooker with direct and indirect heating). First, water was poured into the cooker. Reduce water by 50-65% due to steam condensate during direct steam injection. The cooker was set at 135-140° F. (57.2-60° C.) by applying indirect heat and speed at 96-120 rpm. The preservative was added and blended for 1 minute. Then, the cultured base, tricalcium phosphate, and color were added while maintaining temperature at 135-140° F. (57.2-60° C.) by applying indirect heat and blended for 1 minute. The pre-warmed coconut oil (115-120° F.; 46.1-48.9° C.), citric acid, tartaric acid, and flavors were added and blended for 2 minutes. The indirect heat was then turned off and pre-blended bamboo fiber, starches/potato protein, and salt were added. Direct steam injection heat was then applied to 176-185° F. (80-85° C.), maintaining this temperature for 8-10 minutes at 140 rpm. The pH and total solids/moisture content were tested and adjusted as needed. The mixture was then added into clean, dry stainless-steel pans lined with clean heat-resistant plastic bags and placed in a cooler (36-43° F.; 2.2-6.1° C.) to harden for 5 days or until the final product was set. The product was then cut into smaller blocks and diced using a cheese dicer. The diced plant-based cheese pieces were weighed in a clean bucket. Then, blended cellulose gel anti-caking agent and potassium salt flour mix were sprinkled to evenly coat the diced pieces. The finished product was packaged in plastic bags, sealed, and refrigerated at 36-43° F. (2.2-6.1° C.).

A summary of the chemical characteristics of example plant-based feta cheese-style blocks and diced compositions is provided in Table 10.

TABLE 10
Chemical characteristics of example plant-based
feta cheese-style blocks and diced compositions.

| | Specification |
|---|---|
| Feta Cheese-Style (Blocks) | |
| Fat (%) | 20.9-21.9 (Target = 21.4) |
| Total Solids (%) | 48.52-50.52 (Target = 49.52) |
| Moisture (%) | 49.48-51.48 (Target = 50.48) |
| pH immediately after batching | 3.55-3.75 (Target = 3.65) |
| (measured at 40-44° C.) | |
| pH of refrigerated block | 3.85-4.15 (Target = 4.00) |
| Feta Cheese-Style (Diced) | |
| Fat (%) | 20.1-21.1 (Target = 20.6) |
| Total Solids (%) | 52.52-54.52 (Target = 53.52) |
| Moisture (%) | 45.48-47.48 (Target = 46.48) |
| pH of finished product | 3.90-4.10 (Target = 4.00) |

### Example 5

### The Effects of Different Insoluble Fiber Concentrations on the Textural Properties of Plant-Based Mozzarella Cheese-Style Products

Different concentration levels of insoluble bamboo fiber (e.g., 0, 1.5, 3.0, 4.5 wt %) were tested in 1500 g plant-based mozzarella cheese-style shred compositions to study the effects on textural properties. The different batch formulations tested are shown in Table 11.

TABLE 11
Tested batch formulations of plant-based mozzarella cheese-style
shreds having different concentration levels of insoluble fiber.

| | | | Batch 2 | | Batch 3 | | Batch 4 | |
|---|---|---|---|---|---|---|---|---|
| | Batch 1 | | (1.5% Insoluble | | (3.0% Insoluble | | (4.5% Insoluble | |
| | (No Fiber) | | Fiber) | | Fiber) | | Fiber) | |
| | | Mass | | Mass | | Mass | | Mass |
| Ingredient | wt % | (g) | wt % | (g) | wt % | (g) | wt % | (g) |
| Emulsifying | 4.3068 | 64.60 | 4.3068 | 64.60 | 4.3068 | 64.60 | 4.3068 | 64.60 |
| Potato Starch | | | | | | | | |
| Viscosifying | 19.6279 | 294.42 | 19.6279 | 294.42 | 19.6279 | 294.42 | 19.6279 | 294.42 |
| Potato Starch | | | | | | | | |
| and Potato | | | | | | | | |
| Protein | | | | | | | | |
| Water | 33.9005 | 508.51 | 32.4005 | 486.01 | 30.9005 | 463.51 | 29.4005 | 441.01 |
| Vegan Cultured | 19.3734 | 290.60 | 19.3734 | 290.60 | 19.3734 | 290.60 | 19.3734 | 290.60 |
| Base | | | | | | | | |
| Coconut Oil | 19.0314 | 285.47 | 19.0314 | 285.47 | 19.0314 | 285.47 | 19.0314 | 285.47 |
| Insoluble | 0 | 0 | 1.5000 | 22.50 | 3.0000 | 45.00 | 4.5000 | 67.50 |
| Bamboo Fiber | | | | | | | | |
| Salt | 1.7000 | 25.50 | 1.7000 | 25.50 | 1.7000 | 25.50 | 1.7000 | 25.50 |
| Natural Flavors | 0.2800 | 4.20 | 0.2800 | 4.20 | 0.2800 | 4.20 | 0.2800 | 4.20 |
| Tricalcium | 1.0000 | 15.00 | 1.0000 | 15.00 | 1.0000 | 15.00 | 1.0000 | 15.00 |
| Phosphate | | | | | | | | |
| (TCP) | | | | | | | | |
| Gellan Gum | 0.2900 | 4.35 | 0.2900 | 4.35 | 0.2900 | 4.35 | 0.2900 | 4.35 |
| Konjac Gum | 0.2900 | 4.35 | 0.2900 | 4.35 | 0.2900 | 4.35 | 0.2900 | 4.35 |
| Citric Acid | 0.1000 | 1.50 | 0.1000 | 1.50 | 0.1000 | 1.50 | 0.1000 | 1.50 |
| Potassium | 0.1000 | 1.50 | 0.1000 | 1.50 | 0.1000 | 1.50 | 0.1000 | 1.50 |
| Sorbate | | | | | | | | |
| TOTAL | 100.0000 | 1500.00 | 100.0000 | 1500.00 | 100.0000 | 1500.00 | 100.0000 | 1500.00 |

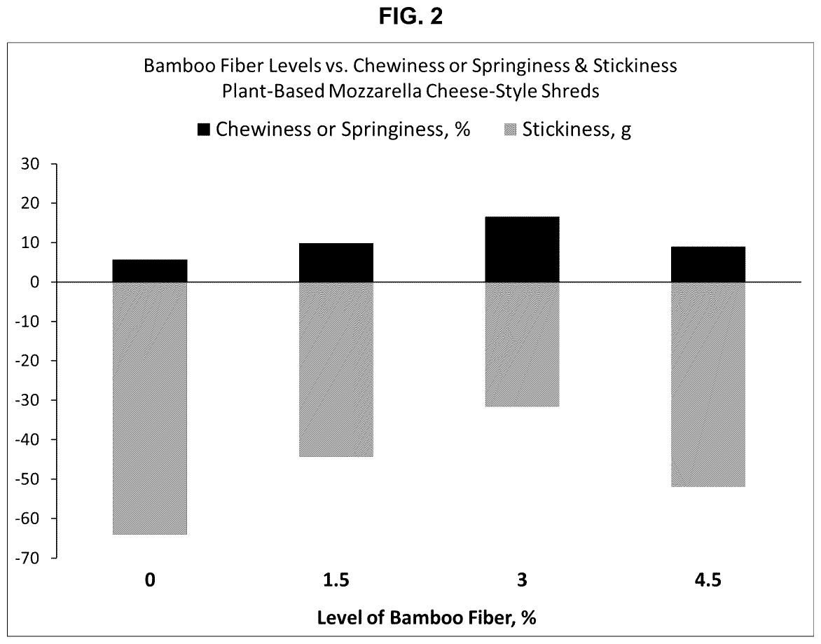

The plant-based mozzarella cheese-style shreds were found to exhibit the highest level of chewiness/springiness and the lowest level of stickiness when bamboo fiber was present at a concentration of 3 wt % (FIG. 2). The samples without any bamboo fiber (i.e., 0 wt %) were found to be the least chewy/springy and the stickiest (FIG. 2). The raw data for these studies are shown in Table 12.

TABLE 12
Measured chewiness/springiness and stickiness properties
of plant-based mozzarella cheese-style shreds having
different concentration levels of insoluble fiber.

| Insoluble | Replicate | Chewiness or | |
|---|---|---|---|
| Bamboo Fiber | and | Springiness | Stickiness |
| (wt %) | Average | (%) | (g) |
| 0 | 1 | 7.53 | −54.60 |
| | 2 | 3.88 | −73.63 |
| | Average | 5.71 | −64.11 |
| 1.5 | 1 | 12.83 | −36.35 |
| | 2 | 6.93 | −52.67 |
| | Average | 9.88 | −44.51 |
| 3.0 | 1 | 22.21 | −31.86 |
| | 2 | 10.91 | −31.72 |
| | Average | 16.56 | −31.79 |
| 4.5 | 1 | 10.58 | −36.49 |
| | 2 | 7.34 | −67.43 |
| | Average | 8.96 | −51.96 |

### Example 6

The Effects of Insoluble Fiber vs. Soluble Fiber on the Textural Properties of Plant-Based Mozzarella Cheese-Style Products

Plant-based mozzarella cheese-style shred compositions (1500 g) having either insoluble bamboo fiber (3.0 wt %) or soluble corn fiber (3.0 wt %) were tested to study the effects on textural properties. Different levels of emulsifying and viscosifying (i.e., gelling) starches were also tested with both the insoluble bamboo fiber and soluble corn fiber batches. The different batch formulations tested are shown in Table 13.

TABLE 13
Tested batch formulations of plant-based mozzarella cheese-style shreds
having either insoluble bamboo fiber or soluble corn fiber and different
levels of emulsifying and viscosifying/gelling starches.

| | Batch 1 | | Batch 2 | | Batch 3 | | Batch 4 | |
|---|---|---|---|---|---|---|---|---|
| | | Mass | | Mass | | Mass | | Mass |
| Ingredient | wt % | (g) | wt % | (g) | wt % | (g) | wt % | (g) |
| Emulsifying | 4.3068 | 64.60 | 4.3068 | 64.60 | 8.9347 | 134.02 | 8.9347 | 134.02 |
| Potato Starch | | | | | | | | |
| Viscosifying | 19.6279 | 294.42 | 19.6279 | 294.42 | 15.0000 | 225.00 | 15.0000 | 225.00 |
| Potato Starch | | | | | | | | |
| and Potato | | | | | | | | |
| Protein | | | | | | | | |
| Water | 30.9110 | 463.67 | 30.9110 | 463.67 | 30.9110 | 463.67 | 30.9110 | 463.67 |
| Vegan Cultured | 19.3734 | 290.60 | 19.3734 | 290.60 | 19.3734 | 290.60 | 19.3734 | 290.60 |
| Base | | | | | | | | |
| Coconut Oil | 19.0314 | 285.47 | 19.0314 | 285.47 | 19.0314 | 285.47 | 19.0314 | 285.47 |
| Insoluble | 3.0000 | 45.00 | 0 | 0 | 3.0000 | 45.00 | 0 | 0 |
| Bamboo Fiber | | | | | | | | |
| Soluble Corn | 0 | 0 | 3.0000 | 45.00 | 0 | 0 | 3.0000 | 45.00 |
| Fiber | | | | | | | | |
| Salt | 1.7000 | 25.50 | 1.7000 | 25.50 | 1.7000 | 25.50 | 1.7000 | 25.50 |
| Natural Flavors | 0.2800 | 4.20 | 0.2800 | 4.20 | 0.2800 | 4.20 | 0.2800 | 4.20 |
| Tricalcium | 1.0000 | 15.00 | 1.0000 | 15.00 | 1.0000 | 15.00 | 1.0000 | 15.00 |
| Phosphate | | | | | | | | |
| (TCP) | | | | | | | | |
| Gellan Gum | 0.2900 | 4.35 | 0.2900 | 4.35 | 0.2900 | 4.35 | 0.2900 | 4.35 |
| Konjac Gum | 0.2900 | 4.35 | 0.2900 | 4.35 | 0.2900 | 4.35 | 0.2900 | 4.35 |
| Citric Acid | 0.0800 | 1.20 | 0.0800 | 1.20 | 0.0800 | 1.20 | 0.0800 | 1.20 |
| Potassium | 0.1000 | 1.50 | 0.1000 | 1.50 | 0.1000 | 1.50 | 0.1000 | 1.50 |
| Sorbate | | | | | | | | |
| Beta-carotene | 0.0095 | 0.14 | 0.0095 | 0.14 | 0.0095 | 0.14 | 0.0095 | 0.14 |
| (color) | | | | | | | | |
| TOTAL | 100.0000 | 1500.00 | 100.0000 | 1500.00 | 100.0000 | 1500.00 | 100.0000 | 1500.00 |

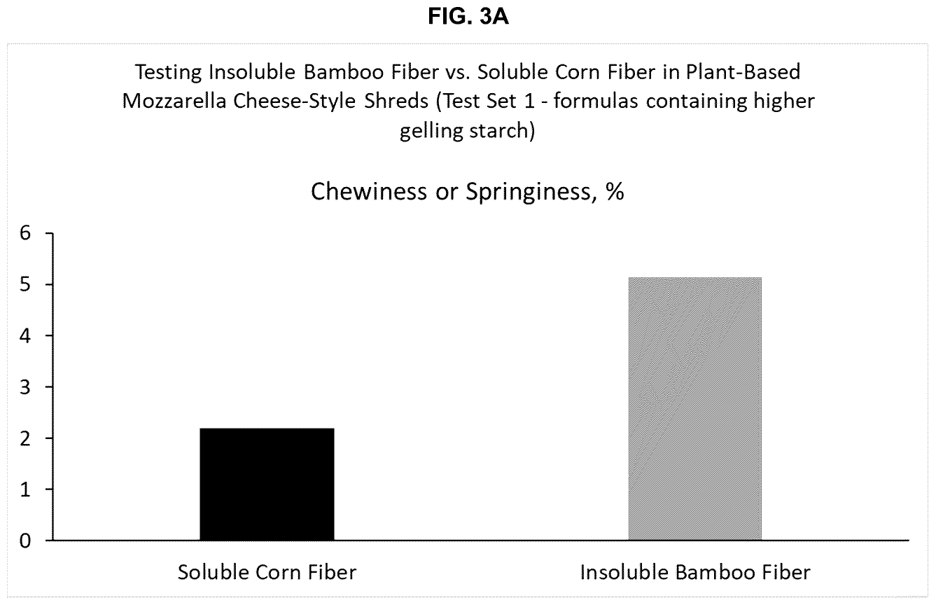

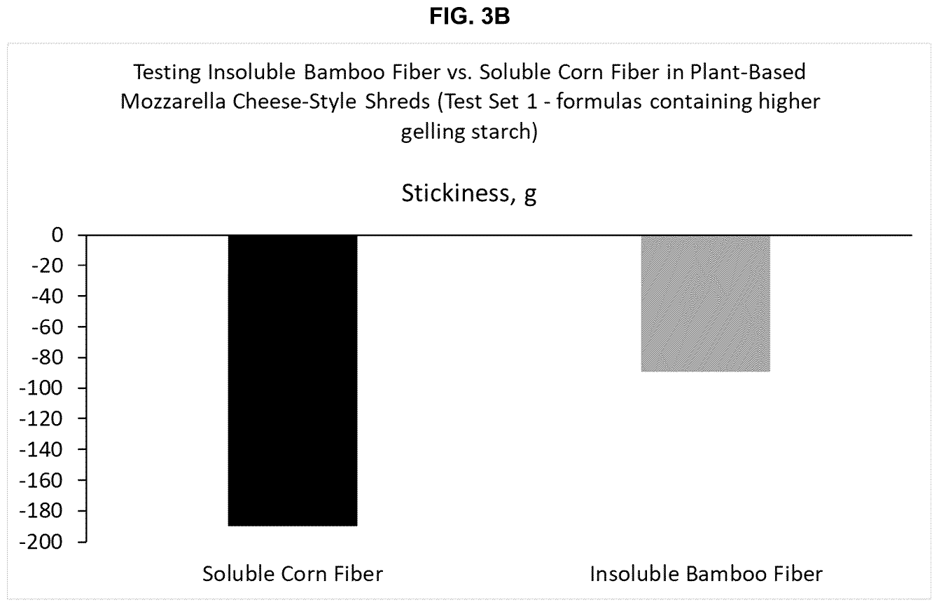

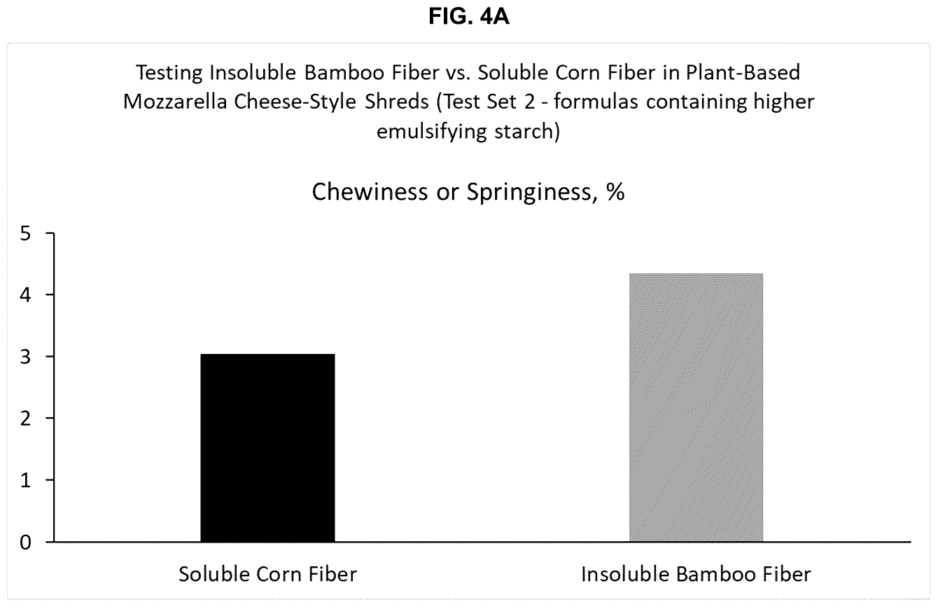

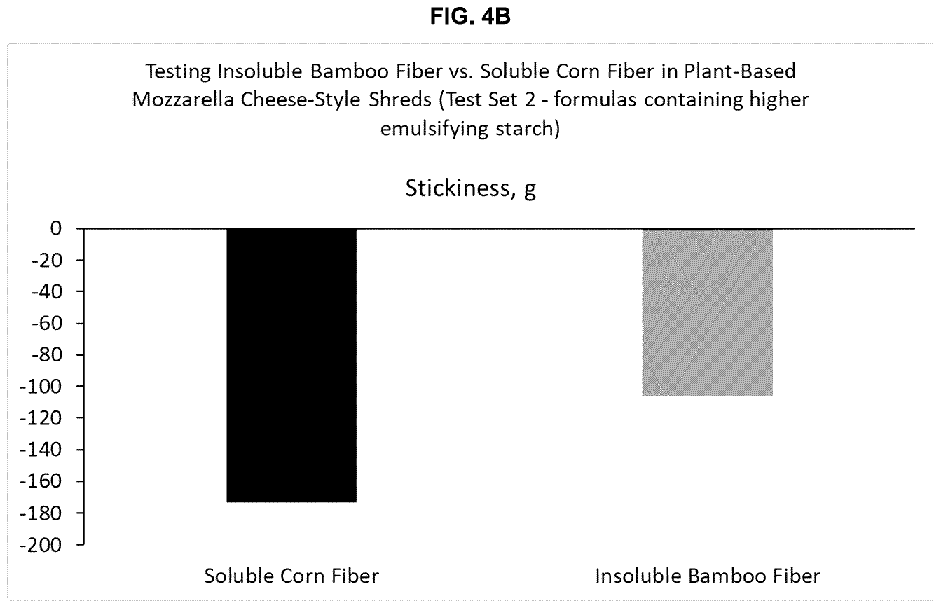

The plant-based mozzarella cheese-style shreds were found to exhibit higher levels of chewiness/springiness and lower levels of stickiness when insoluble bamboo fiber (3.0 wt %) was included, as compared to soluble corn fiber (3.0 wt %), regardless of the emulsifying and viscosifying/gelling starch content (FIGS. 3A-3B and FIG. 4A-4B). The raw data for these studies are shown in Table 14.

TABLE 14
Measured chewiness/springiness and stickiness properties of
plant-based mozzarella cheese-style shreds having either
insoluble bamboo fiber or soluble corn fiber and different
levels of emulsifying and viscosifying/gelling starches.

| | Batch # | | |
|---|---|---|---|
| | (Replicate | Chewiness or | |
| | and | Springiness | Stickiness |
| Sample Description | Average) | (%) | (g) |
| contains insoluble | 1a | 6.64 | −61.10 |
| fiber, higher gelling | 1b | 3.65 | −117.35 |
| starch | Average | 5.15 | −89.23 |
| contains soluble | 2a | 1.69 | −215.03 |
| fiber, higher gelling | 2b | 2.71 | −164.98 |
| starch | Average | 2.20 | −190.00 |
| contains insoluble | 3a | 4.89 | −80.14 |
| fiber, higher | 3b | 3.82 | −131.83 |
| emulsifying starch | Average | 4.35 | −105.98 |
| contains soluble | 4a | 4.43 | −106.52 |
| fiber, higher | 4b | 1.65 | −240.48 |
| emulsifying starch | Average | 3.04 | −173.50 |

### Example 7

The Effects of Insoluble Fiber vs. No Fiber on the Textural Properties of Plant-Based Mozzarella Cheese-Style Stick Base Compositions

Plant-based mozzarella cheese-style stick base compositions (1500 g) having either insoluble bamboo fiber (3.0 wt %) or no fiber content (0 wt %) were tested to study the effects on textural properties. The different batch formulations tested are shown in Table 15. The solids content was kept the same in both batches, i.e., with the 3% fiber added in Batch 2, the viscosifying starch was adjusted to maintain the same solids in both batches.

TABLE 15
Tested batch formulations of plant-based mozzarella cheese-style
stick bases having either insoluble bamboo fiber or no fiber.

| | Batch 1 | | Batch 2 | |
|---|---|---|---|---|
| Ingredient | wt % | Mass (g) | wt % | Mass (g) |
| Water | 34.8866 | 523.30 | 34.8866 | 523.30 |
| Viscosifying Potato | 24.7234 | 370.85 | 21.7234 | 325.85 |
| Starch and Potato Protein | | | | |
| Insoluble Bamboo Fiber | 0 | 0 | 3.0000 | 45.00 |
| Vegan Cultured Base | 17.0506 | 255.76 | 17.0506 | 255.76 |
| Coconut Oil | 16.7948 | 251.92 | 16.7948 | 251.92 |
| Sunflower Oil | 1.9200 | 28.80 | 1.9200 | 28.80 |
| Salt | 1.4173 | 21.26 | 1.4173 | 21.26 |
| Natural Flavor | 1.1510 | 17.27 | 1.1510 | 17.27 |
| Tricalcium Phosphate | 0.5900 | 8.85 | 0.5900 | 8.85 |
| (TCP) | | | | |
| Hydroxypropyl | 0.4800 | 7.20 | 0.4800 | 7.20 |
| Methylcellulose (HPMC) | | | | |
| Sunflower Lecithin | 0.2558 | 3.84 | 0.2558 | 3.84 |
| Gellan Gum | 0.2558 | 3.84 | 0.2558 | 3.84 |
| Konjac Gum | 0.2558 | 3.84 | 0.2558 | 3.84 |
| Tripotassium Phosphate | 0.1108 | 1.66 | 0.1108 | 1.66 |
| (TKP) | | | | |
| Beta-carotene (color) | 0.0081 | 0.12 | 0.0081 | 0.12 |
| Potassium Sorbate | 0.1000 | 1.50 | 0.1000 | 1.50 |
| TOTAL | 100.0000 | 1500.00 | 100.0000 | 1500.00 |

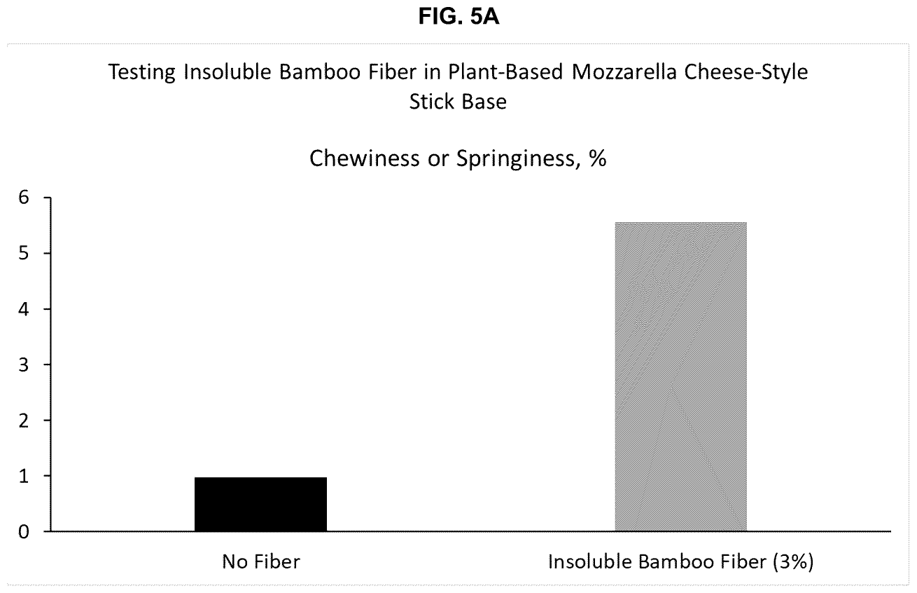

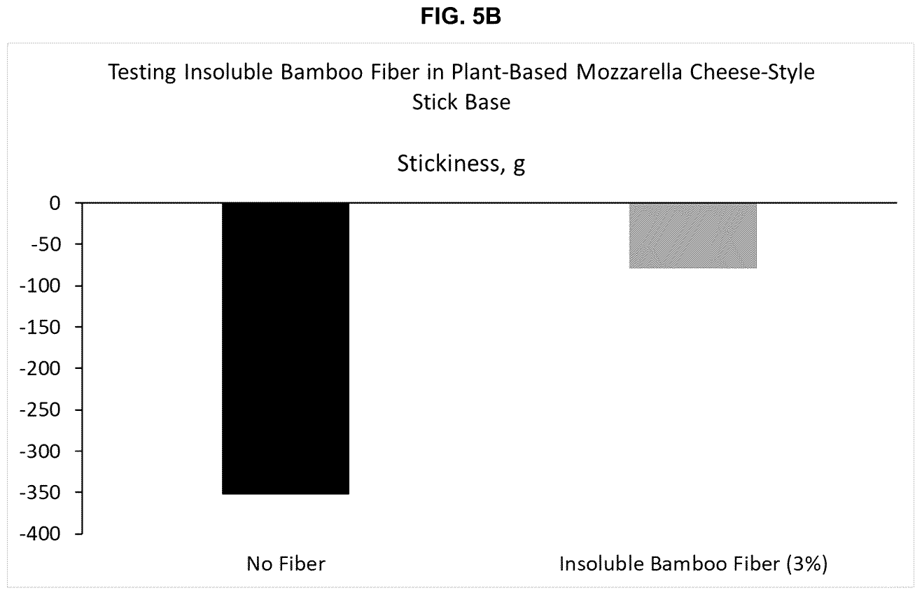

The plant-based mozzarella cheese-style stick bases were found to exhibit higher levels of chewiness/springiness and lower levels of stickiness when insoluble bamboo fiber (3.0 wt %) was included, as compared to no fiber (FIG. 5A-5B). The raw data for these studies are shown in Table 16.

TABLE 16
Measured chewiness/springiness and stickiness properties
of plant-based mozzarella cheese-style stick bases
having either insoluble bamboo fiber or no fiber.

| | Batch # | Chewiness or | |
|---|---|---|---|
| Sample | (Replicate | Springiness | Stickiness |
| Description | and Average) | (%) | (g) |
| contains no | 1a | 0.96 | −328.32 |
| fiber | 1b | 0.97 | −377.58 |
| | Average | 0.97 | −352.95 |
| contains | 2a | 5.08 | −90.76 |
| insoluble | 2b | 6.04 | −68.80 |
| fiber (3 wt %) | Average | 5.56 | −79.78 |

### Example 8

### Comparison of Plant-Based Mozzarella Cheese-Style Shreds to Different Commercially Available Dairy-Free Cheese Products

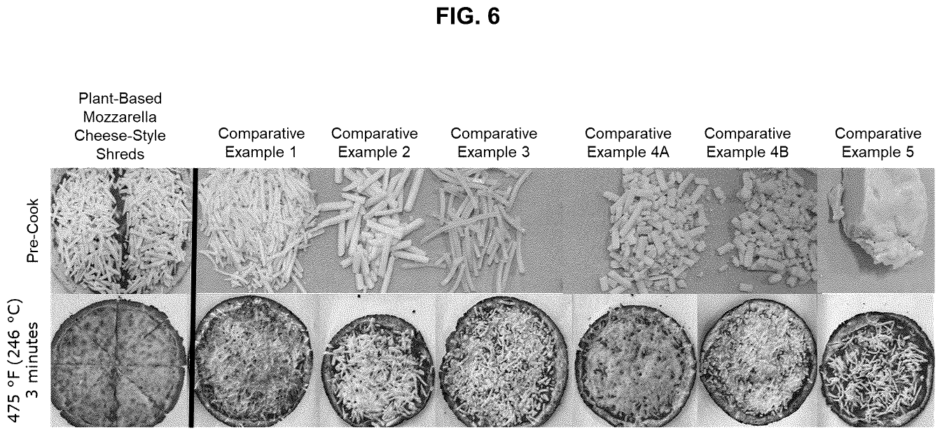

FIG. 6 shows a photographic comparison demonstrating the textural differences between the disclosed plant-based mozzarella cheese-style shreds having 3 wt % insoluble bamboo fiber and various commercially available dairy-free cheese products (Comparative Examples 1-5) in a pizza melt application. Photographs of each sample were taken pre-cook and after cooking at 475° F. (246° C.) for 3 minutes in an impinger oven. The plant-based mozzarella cheese-style shreds having insoluble fiber that were used in this example were produced using the materials and methods described in Example 2 above (3.0% bamboo fiber composition shown in Table 6). The ingredients for each of the commercially available dairy-free cheese products (Comparative Examples 1-5) are provided below.

Comparative Example 1 (mozzarella style shreds): filtered water, coconut oil, food starch-modified (potato and corn), corn starch, sea salt, mozzarella flavor (vegan sources), olive extract, beta carotene (color), vitamin B12, and powdered cellulose to prevent caking.

Comparative Example 2 (mozzarella style shreds): filtered water, coconut oil, food starch (potato and tapioca), sunflower oil, natural flavors (vegan sources), chickpea protein, calcium citrate, sea salt, Konjac gum, xanthan gum, annatto and turmeric extracts (color), and powdered cellulose to prevent caking.

Comparative Example 3 (mozzarella style shreds): filtered water, tapioca starch, coconut oil, expeller-pressed canola and/or safflower oil, vegan natural flavors, chickpea protein, salt, potato protein, tricalcium phosphate, lactic acid (vegan), Konjac gum, xanthan gum, yeast extract, and fruit and/or vegetable juice color.

Comparative Example 4A (pizzeria blend of mozzarella and parmesan style shreds): Dairy-free mozzarella style shreds: filtered water, organic palm fruit oil, modified food starch, natural flavors, less than 2% of: pea fiber, pea starch, bamboo fiber, calcium phosphate, rice flour, vegetable glycerin, sunflower lecithin, sea salt, sunflower oil, carrageenan, calcium sulfate, citric acid, microbial enzymes, xanthan gum, disodium phosphate, and sodium citrate; Dairy-free parmesan style shreds: filtered water, organic palm fruit oil, modified food starch, canola oil, natural flavors (contains autolyzed yeast), vegetable glycerin, less than 2% of: sunflower oil, lactic acid, calcium lactate, sea salt, sodium phosphate, carrageenan, calcium sulfate, bamboo fiber, nutritional yeast, calcium phosphate, organic chickpea miso (organic handmade rice koji, organic whole chickpeas, sea salt, water, koji spores), sunflower lecithin, citric acid, microbial enzymes, and annatto.

Comparative Example 4B (mozzarella style shreds): filtered water, organic coconut oil, potato and corn starch, expeller-pressed canola oil, sea salt, less than 2% of: natural flavors, potato protein, calcium phosphate, organic vegan cane sugar, organic vegetable glycerin, cellulose, sodium citrate, citric acid, lactic acid, sodium bicarbonate, and beta carotene (color).

Comparative Example 5 (cashew milk mozzarella): organic cashew milk (filtered water, organic cashews), organic coconut oil, organic tapioca starch, sea salt, organic agar, mushroom extract, organic Konjac, and cultures.

The disclosed plant-based mozzarella cheese-style shreds having 3 wt % insoluble bamboo fiber had better melt, mouthfeel, and overall textural properties as compared to all the commercially available dairy-free Comparative Examples 1-5 that were tested (FIG. 6).

### Example 9

### Comparison of Plant-Based Mozzarella Cheese-Style Shreds Having Different Types of Insoluble Fiber

Experiments were performed to compare the exemplary plant-based mozzarella cheese-style shred compositions having either no fiber or 3 wt % insoluble bamboo fiber (from Example 2 above) to a plant-based mozzarella cheese-style shred composition having 3 wt % insoluble oat fiber. The different shred formulations tested are shown in Table 17.

TABLE 17
Example plant-based mozzarella cheese-style shred compositions having
no fiber, insoluble oat fiber, or insoluble bamboo fiber.

| | | 3.0% | 3.0% |
|---|---|---|---|
| | No | Oat | Bamboo |
| | Fiber | Fiber | Fiber |
| Ingredient | wt % | wt % | wt % |
| Emulsifying Potato Starch | 8.9347 | 8.9347 | 8.9347 |
| Viscosifying Potato | 13.0000 | 13.0000 | 13.0000 |
| Starch and Potato Protein | | | |
| Water | 36.0056 | 33.0056 | 33.0056 |
| Vegan Cultured Base | 19.3734 | 19.3734 | 19.3734 |
| Coconut Oil | 19.0314 | 19.0314 | 19.0314 |
| Insoluble Oat Fiber | 0 | 3.0000 | 0 |
| Insoluble Bamboo Fiber | 0 | 0 | 3.0000 |
| Salt | 1.7054 | 1.7054 | 1.7054 |
| Natural Flavors | 0.4000 | 0.4000 | 0.4000 |
| Tricalcium Phosphate (TCP) | 1.0000 | 1.0000 | 1.0000 |
| Konjac Gum | 0.2900 | 0.2900 | 0.2900 |
| Citric Acid | 0.1500 | 0.1500 | 0.1500 |
| Potassium Sorbate | 0.1000 | 0.1000 | 0.1000 |
| (Preservative) | | | |
| Beta-carotene (color) | 0.0095 | 0.0095 | 0.0095 |
| TOTAL | 100.000 | 100.000 | 100.000 |

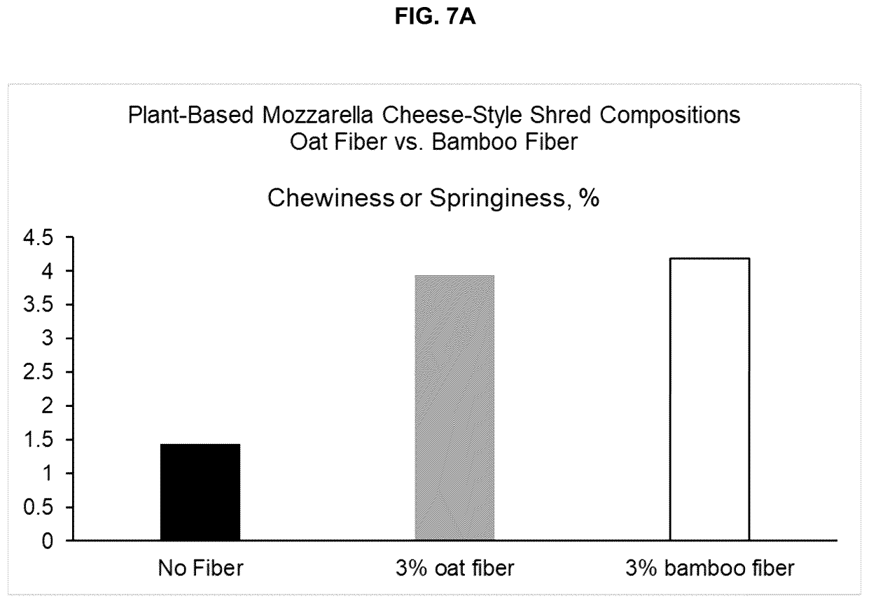

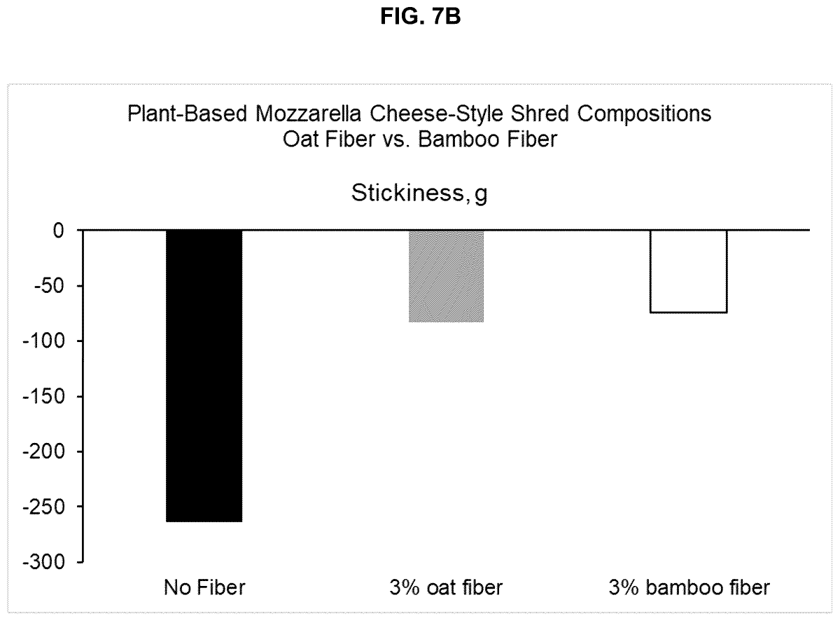

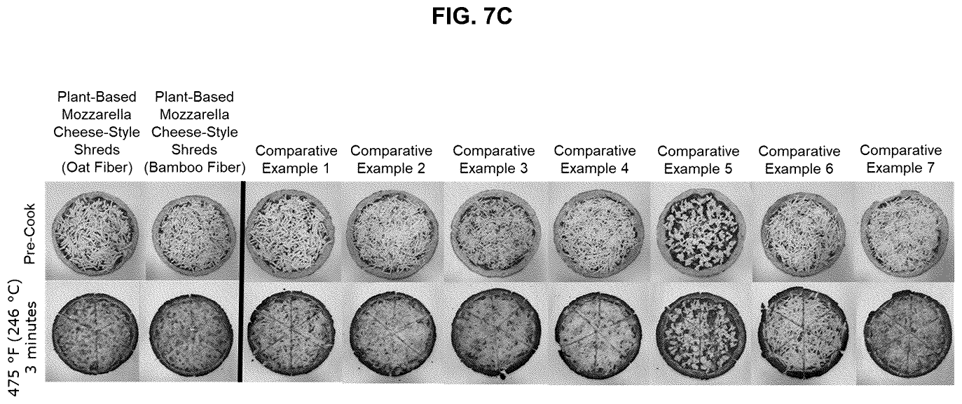

Both plant-based mozzarella cheese-style shred compositions having 3 wt % of the different insoluble fibers were found to exhibit significantly higher levels of measured chewiness/springiness (FIG. 7A) and significantly lower levels of measured stickiness (FIG. 7B) as compared to the shred composition having no fiber. However, no significant differences were observed in the measured chewiness/springiness or stickiness properties between the plant-based mozzarella cheese-style shred compositions having 3 wt % insoluble oat fiber vs. 3 wt % insoluble bamboo fiber (FIG. 7A-7B).

In addition, the disclosed plant-based mozzarella cheese-style shred compositions having either 3 wt % insoluble oat fiber or 3 wt % insoluble bamboo fiber (compositions shown in Table 17) were compared to various commercially available dairy-free cheese products (Comparative Examples 1-7) in a pizza melt application, similar to Example 8 above.

FIG. 7C shows a photographic comparison demonstrating the textural differences between the plant-based mozzarella cheese-style shreds having either 3 wt % insoluble oat fiber or 3 wt % insoluble bamboo fiber and the various commercially available dairy-free cheese products. Photographs of each sample were taken pre-cook and after cooking at 475° F. (246° C.) for 3 minutes in an impinger oven. The ingredients for each of the commercially available dairy-free cheese products (Comparative Examples 1-7) are provided below.

Comparative Example 1 (mozzarella style shreds): filtered water, coconut oil, food starch-modified (potato and corn), corn starch, sea salt, mozzarella flavor (vegan sources), olive extract, beta carotene (color), vitamin B12, and powdered cellulose to prevent caking.

Comparative Example 2 (mozzarella style shreds): filtered water, coconut oil, food starch (potato and tapioca), sunflower oil, natural flavors (vegan sources), chickpea protein, calcium citrate, sea salt, Konjac gum, xanthan gum, annatto and turmeric extracts (color), and powdered cellulose to prevent caking.

Comparative Example 3 (mozzarella style shreds): filtered water, tapioca flour, coconut oil, expeller-pressed canola and/or safflower oil, vegan natural flavors, chickpea protein, salt, tricalcium phosphate, lactic acid (vegan), Konjac flour, xanthan gum, yeast extract, and fruit and/or vegetable juice color.

Comparative Example 4 (mozzarella style shreds): filtered water, organic coconut oil, potato and corn starch, expeller-pressed canola oil, sea salt, less than 2% of: natural flavors, potato protein, calcium phosphate, organic vegan cane sugar, organic vegetable glycerin, cellulose, sodium citrate, citric acid, lactic acid, sodium bicarbonate, and beta carotene (color).

Comparative Example 5 (cashew milk mozzarella): organic cashew milk (filtered water, organic cashews), organic coconut oil, organic tapioca starch, sea salt, organic agar, mushroom extract, organic Konjac, and cultures.

Comparative Example 6: filtered water, highly refined coconut oil, modified potato starch, modified tapioca starch, potato starch, sea salt, olive extract, and natural flavor.

Comparative Example 7: water, modified food starch, coconut oil, sea salt, fava bean protein, natural flavor, calcium phosphate, turmeric oleoresin and annatto extract (color), and pea starch to prevent caking.

The disclosed plant-based mozzarella cheese-style shreds having either 3 wt % insoluble oat fiber or 3 wt % insoluble bamboo fiber had better melt, mouthfeel, and overall textural properties as compared to all the commercially available dairy-free Comparative Examples 1-7 that were tested (FIG. 7C). However, no significant differences were observed in the melt, mouthfeel, and overall textural properties between the disclosed plant-based mozzarella cheese-style shred compositions having 3 wt % insoluble oat fiber vs. 3 wt % insoluble bamboo fiber (FIG. 7C).

### Example 10

### Microscopic Analysis of Plant-Based Mozzarella Cheese-Style Shreds

Confocal microscopy experiments were performed to visualize the interaction and spatial distribution of lipids, proteins, and fibers within the exemplary plant-based mozzarella cheese-style shred compositions having either no fiber or 3 wt % insoluble bamboo fiber (from Example 2 above).

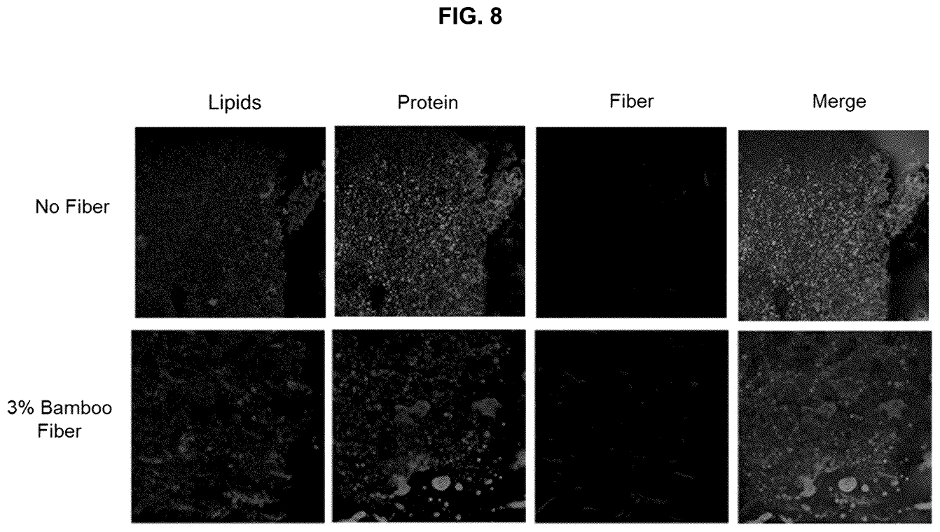

FIG. 8 shows a microscopic image analysis comparing the interaction and spatial distribution of lipids, proteins, and fibers between the two different plant-based mozzarella cheese-style shred compositions. Confocal laser scanning microscopy was used to obtain the images. The samples were stained using the following specific dyes: Nile Red (NR) for visualization of lipids; Fast Green (FG) for visualization of proteins; and CalcoFluorWhite (CFW) for visualization of fibers. CFW is commonly used to stain β1-3 and β1-4 polysaccharides, such as those found in cellulose or chitin.

The plant-based mozzarella cheese-style shred composition having 3 wt % insoluble bamboo fiber was found to have a more heterogeneous lipid and protein microstructure with larger protein aggregation and a distinct association with lipids, as compared to the shred composition having no fiber (FIG. 8). This observed effect may contribute to the reduced perception and measured stickiness of the disclosed plant-based mozzarella cheese-style shred compositions that include insoluble fiber.

### Example 11

### Melt Analysis of Plant-Based Mozzarella Cheese-Style Shreds

Meltability experiments were performed using a standard Schreiber test to evaluate the differences in melt between two different plant-based mozzarella cheese-style shred compositions having either 3 wt % insoluble bamboo fiber or 3 wt % insoluble oat fiber (Table 18) and various commercially available dairy-free cheese products (Comparative Examples 1-7).

TABLE 18
Example plant-based mozzarella cheese-style shred
compositions having insoluble bamboo fiber or insoluble
oat fiber used for meltability experiments.

| | 3.0% | | 3.0% | |
|---|---|---|---|---|
| | Bamboo Fiber | | Oat Fiber | |
| Ingredient | wt % | grams | wt % | grams |
| Emulsifying Potato Starch | 8.9347 | 178.69 | 8.9347 | 178.69 |
| Viscosifying Potato Starch | 13.0000 | 260.00 | 13.0000 | 260.00 |
| and Potato Protein | | | | |
| Water | 33.0056 | 660.11 | 33.0056 | 660.11 |
| Vegan Cultured Base | 19.3734 | 387.47 | 19.3734 | 387.47 |
| Coconut Oil | 19.0314 | 380.63 | 19.0314 | 380.63 |
| Insoluble Bamboo Fiber | 3.0000 | 60.00 | 0 | 0 |
| Insoluble Oat Fiber | 0 | 0 | 3.0000 | 60.00 |
| Salt | 1.7054 | 34.11 | 1.7054 | 34.11 |
| Natural Flavors | 0.4000 | 8.00 | 0.4000 | 8.00 |
| Tricalcium Phosphate | 1.0000 | 20.00 | 1.0000 | 20.00 |
| (TCP) | | | | |
| Konjac Gum | 0.2900 | 5.80 | 0.2900 | 5.80 |
| Citric Acid | 0.1500 | 3.00 | 0.1500 | 3.00 |
| Potassium Sorbate | 0.1000 | 2.00 | 0.1000 | 2.00 |
| (Preservative) | | | | |
| Beta-carotene (color) | 0.0095 | 0.19 | 0.0095 | 0.19 |
| TOTAL | 100.0000 | 2000.00 | 100.0000 | 2000.00 |

The ingredients for each of the commercially available dairy-free cheese products (Comparative Examples 1-7) tested in the meltability experiments are provided below.

Comparative Example 1: filtered water, coconut oil, food starch-modified (potato and tapioca), corn starch, sea salt, mozzarella flavor (vegan sources), olive extract, beta carotene (color), vitamin B12, and powdered cellulose to prevent caking.

Comparative Example 2: filtered water, olive oil, potato starch, tapioca starch, faba protein, natural flavors (vegan sources), sea salt, calcium citrate, dextrose, carob bean gum, xanthan gum, annatto and turmeric extracts (color), and powdered cellulose to prevent caking.

Comparative Example 3: oat cream blend (water, oat flour, pea protein, cultures, enzymes), coconut oil, tapioca starch, expeller-pressed safflower oil, corn starch, less than 2% of: Konjac flour, fruit juice (color), yeast extract, salt, dextrose, tricalcium phosphate, xanthan gum, lactic acid, and natural flavors.

Comparative Example 4: filtered water, coconut oil, potato and corn starch, expeller-pressed canola oil, less than 2% of: sea salt, calcium phosphate, potato protein, natural flavors, vegetable glycerin, cellulose, lactic acid, sodium bicarbonate, citric acid, sodium citrate, and beta carotene (color).

Comparative Example 5: organic cashew milk (filtered water, organic cashews), organic coconut oil, organic tapioca starch, sea salt, organic agar, mushroom extract, organic Konjac, and cultures.

Comparative Example 6: water, highly refined coconut oil, modified potato starch, corn starch, modified corn starch, sea salt, natural flavor, olive extract, and beta-carotene (color).

Comparative Example 7: filtered water, coconut oil, potato starch, modified tapioca starch, modified potato starch, chickpea protein concentrate, sea salt, potato protein, natural flavor, lactic acid, annatto (color), turmeric extract, and powdered cellulose to prevent caking.

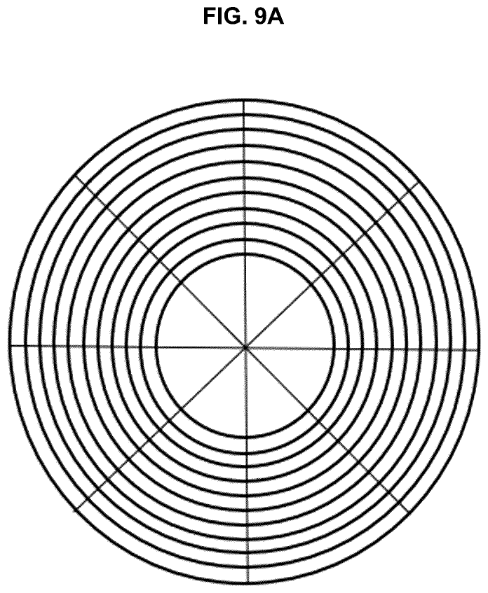

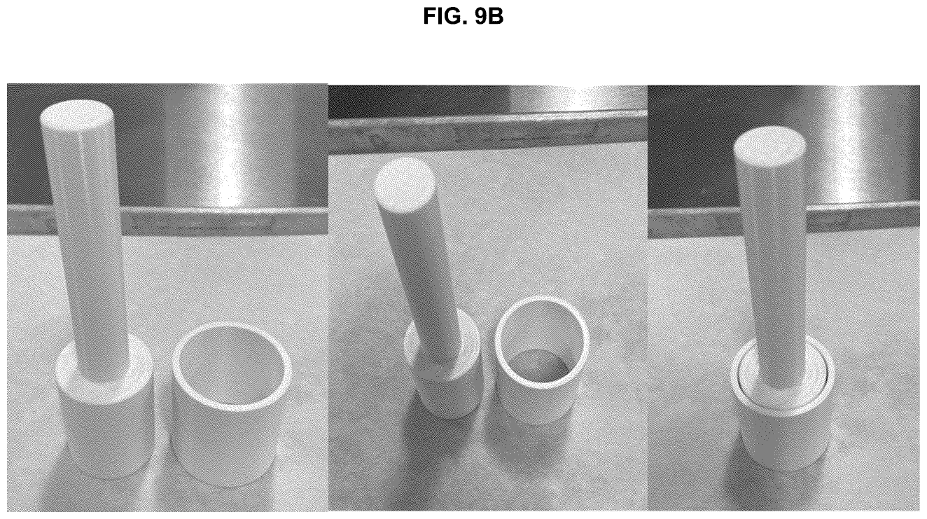

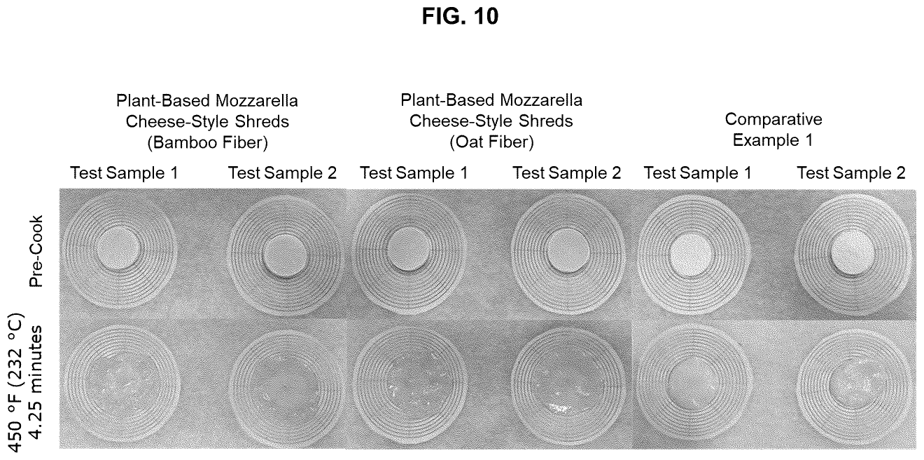

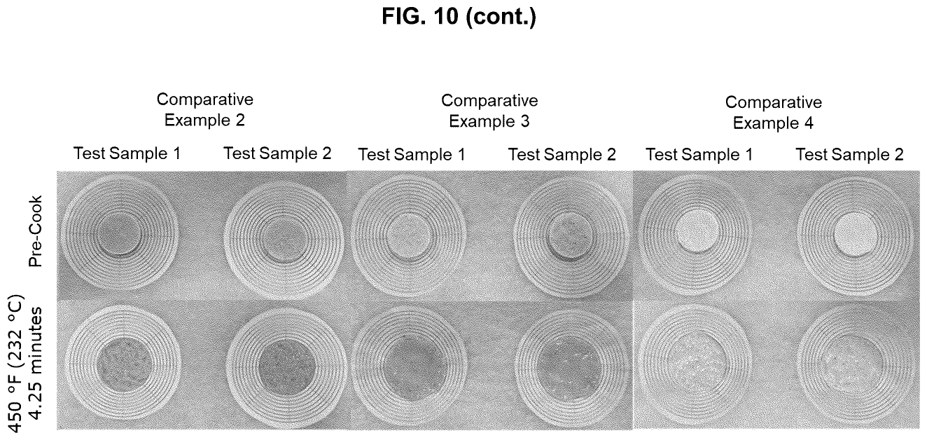

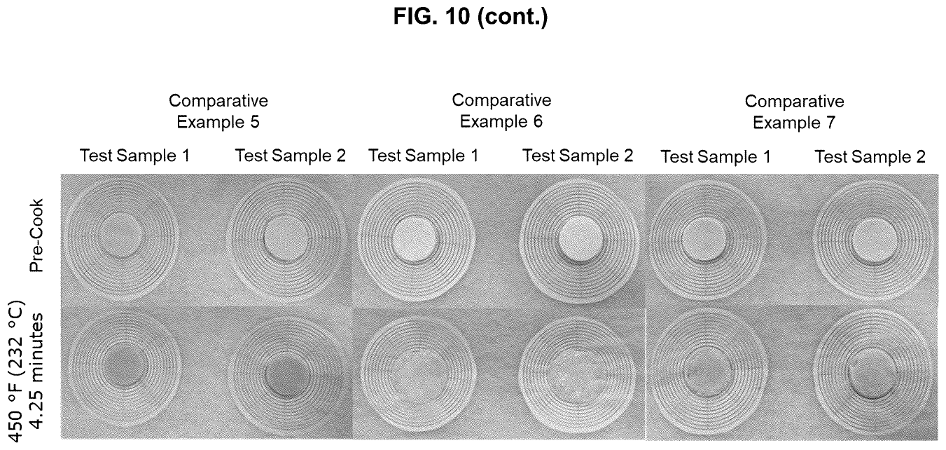

The specific procedure performed for the exemplary meltability experiments using a standard Schreiber test was as follows. Each cheese shreds sample (8 grams each) was formed into a 40-mm diameter disc with a thickness of about 4-5 mm using the molding gadget shown in FIG. 9B. Each cheese shreds sample was tested in duplicate. A sheet of parchment paper was placed on a flat metal tray and two Schreiber stencils (shown in FIG. 9A) were placed separately on top of the parchment paper for each duplicate sample. The Schreiber stencils were then covered with an additional sheet of parchment paper. Each cheese sample disc was placed on top of the parchment paper in the center of the Schreiber stencils. The metal trays holding the cheese sample discs were then placed on the middle rack of a pre-heated oven at 450° F. (232° C.) for 4.25 minutes to melt and spread the samples. The samples were then cooled for 5-10 minutes. The melt or spread of each sample was then calculated in mm as follows. The total melt ring reading from each of the half quadrants of the Schreiber stencil was measured (8 total readings). The Schreiber stencil includes 10 rings outside of the 40-mm initial sample diameter, with the space between each of these 10 rings measuring 3 mm (FIG. 9A). Therefore, the ring melt readings were multiplied by 3. The average of the 8 readings was calculated to represent the total melted sample reading in mm. The actual melt or spread in mm was then calculated by subtracting the initial diameter of 40 mm from the averaged total melted sample reading. The melt results are presented in Table 19 and shown in FIG. 10.

TABLE 19
Melt test data for exemplary plant-based mozzarella cheese-style shred compositions
having insoluble bamboo fiber or insoluble oat fiber compared to commercially
available dairy-free cheese products (Comparative Examples 1-7).

| | Plant-Based Mozzarella | | | Plant-Based Mozzarella | | | | | |
|---|---|---|---|---|---|---|---|---|---|
| | Cheese-Style Shreds | | | Cheese-Style Shreds | | | | | |
| | (Bamboo Fiber) | | | (Oat Fiber) | | | Comparative Example 1 | | |
| | 1 | 2 | Avg. | 1 | 2 | Avg. | 1 | 2 | Avg. |
| Total Melt | 53.7 | 54.6 | 54.2 | 53.1 | 53.7 | 53.4 | 45.4 | 46.9 | 46.2 |
| Diameter, | | | | | | | | | |
| mm | | | | | | | | | |
| Initial | 40.0 | 40.0 | 40.0 | 40.0 | 40.0 | 40.0 | 40.0 | 40.0 | 40.0 |
| Sample | | | | | | | | | |
| Diameter, | | | | | | | | | |
| mm | | | | | | | | | |
| Melt, mm | 13.7 | 14.6 | 14.2 | 13.1 | 13.7 | 13.4 | 5.4 | 6.9 | 6.2 |
| | Comparative Example 2 | | | Comparative Example 3 | | | Comparative Example 4 | | |
| | 1 | 2 | Avg. | 1 | 2 | Avg. | 1 | 2 | Avg. |
| Total Melt | 46.6 | 46.4 | 46.5 | 50.5 | 51.1 | 50.8 | 50.1 | 49.0 | 49.6 |
| Diameter, | | | | | | | | | |
| mm | | | | | | | | | |
| Initial | 40.0 | 40.0 | 40.0 | 40.0 | 40.0 | 40.0 | 40.0 | 40.0 | 40.0 |
| Sample | | | | | | | | | |
| Diameter, | | | | | | | | | |
| mm | | | | | | | | | |
| Melt, mm | 6.6 | 6.4 | 6.5 | 10.5 | 11.1 | 10.8 | 10.1 | 9.0 | 9.6 |
| | Comparative Example 5 | | | Comparative Example 6 | | | Comparative Example 7 | | |
| | 1 | 2 | Avg. | 1 | 2 | Avg. | 1 | 2 | Avg. |
| Total Melt | 40.0 | 40.0 | 40.0 | 47.3 | 47.5 | 47.4 | 43.2 | 42.6 | 42.9 |
| Diameter, | | | | | | | | | |
| mm | | | | | | | | | |
| Initial | 40.0 | 40.0 | 40.0 | 40.0 | 40.0 | 40.0 | 40.0 | 40.0 | 40.0 |
| Sample | | | | | | | | | |
| Diameter, | | | | | | | | | |
| mm | | | | | | | | | |
| Melt, mm | 0 | 0 | 0 | 7.3 | 7.5 | 7.4 | 3.2 | 2.6 | 2.9 |

FIG. 10 shows photographs of the different tested samples on the Schreiber stencils both pre-cook and after melting that generated the melt data presented in Table 19. Overall, the exemplary plant-based mozzarella cheese-style shreds having either insoluble bamboo fiber or insoluble oat fiber exhibited higher melt values as compared to all the commercially available dairy-free Comparative Examples 1-7 that were tested.

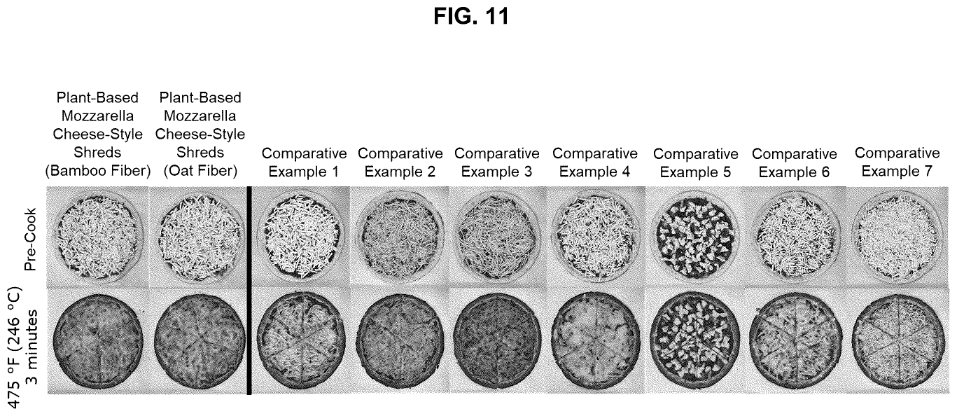

These same samples were then compared in a pizza melt application to further evaluate the differences in melt properties. FIG. 11 shows a photographic comparison demonstrating the differences in melt and textural properties between the cheese shred samples in the pizza melt application. Photographs of each sample were taken pre-cook and after cooking at 475° F. (246° C.) for 3 minutes in an impinger oven. Each 10-inch pizza crust had 100 grams of shreds for each cheese sample. The results further demonstrate that the disclosed plant-based mozzarella cheese-style shreds having 3 wt % insoluble bamboo or oat fiber had better melt and overall textural properties as compared to all the commercially available dairy-free Comparative Examples 1-7 that were tested.

The foregoing description of the specific aspects will so fully reveal the general nature of the invention that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects, but should be defined only in accordance with the following claims and their equivalents.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

For reasons of completeness, various aspects of the invention are set out in the following numbered clauses:
Clause 1. A plant-based cheese-style composition comprising: (a) an insoluble fiber comprising bamboo fiber, rice fiber, wheat fiber, oat fiber, or combinations thereof; (b) one or more starches; (c) one or more oils; (d) a vegan cultured base; and (e) water.
Clause 2. The composition of clause 1, wherein the insoluble fiber comprises bamboo fiber in an amount ranging from about 1.5 wt % to about 4.5 wt % of the plant-based cheese-style composition.
Clause 3. The composition of clause 2, wherein the bamboo fiber is present in an amount of about 3 wt % of the plant-based cheese-style composition.
Clause 4. The composition of any one of clauses 1-3, wherein the insoluble fiber comprises an average fiber length ranging from about 30 μm to about 200 μm.
Clause 5. The composition of any one of clauses 1-4, wherein the insoluble fiber comprises an average fiber length ranging from about 100 μm to about 120 μm.
Clause 6. The composition of any one of clauses 1-5, wherein the insoluble fiber comprises an average fiber length of about 115 μm.
Clause 7. The composition of any one of clauses 1-6, wherein the insoluble fiber comprises an average fiber thickness ranging from about 1 μm to about 40 μm.
Clause 8. The composition of any one of clauses 1-7, wherein the insoluble fiber comprises an average fiber thickness of about 20 μm.
Clause 9. The composition of any one of clauses 1-8, wherein the one or more starches comprises one or more emulsifying starches, one or more viscosifying starches, or a combination thereof.
Clause 10. The composition of clause 9, wherein the one or more emulsifying starches comprises an emulsifying potato starch, and wherein the one or more viscosifying starches comprises a viscosifying potato starch.
Clause 11. The composition of any one of clauses 1-10, wherein the one or more emulsifying starches is present in an amount ranging from about 3.5 wt % to about 9 wt % of the plant-based cheese-style composition, and wherein the one or more viscosifying starches is present in an amount ranging from about 9.5 wt % to about 22 wt % of the plant-based cheese-style composition.
Clause 12. The composition of any one of clauses 1-11, further comprising one or more gums or hydrocolloids comprising gellan gum, Konjac gum, hydroxypropyl methylcellulose (HPMC), xanthan gum, or combinations thereof.
Clause 13. The composition of clause 12, wherein gellan gum is present in an amount ranging from about 0.1 wt % to about 0.3 wt % of the plant-based cheese-style composition, Konjac gum is present in an amount ranging from about 0.1 wt % to about 0.3 wt % of the plant-based cheese-style composition, HPMC is present in an amount up to 0.5 wt % of the plant-based cheese-style composition, xanthan gum is present in an amount up to 0.19 wt % of the plant-based cheese-style composition, or a combination thereof.
Clause 14. The composition of any one of clauses 1-13, wherein the one or more oils comprises coconut oil, sunflower oil, canola oil, or combinations thereof.
Clause 15. The composition of any one of clauses 1-14, wherein the one or more oils is present in an amount ranging from about 15 wt % to about 23 wt % of the plant-based cheese-style composition.
Clause 16. The composition of any one of clauses 1-15, wherein the vegan cultured base comprises one or more bacterial strains comprising Streptococcus thermophilus, Lactobacillus delbrueckii subsp. bulgaricus, Lactobacillus delbrueckii subsp. lactis, Bifidobacterium lactis, Lactobacillus acidophilus, Lactobacillus paracasei, Lactobacillus casei, or combinations thereof.
Clause 17. The composition of any one of clauses 1-16, wherein the vegan cultured base is present in an amount ranging from about 15 wt % to about 30 wt % of the plant-based cheese-style composition.
Clause 18. The composition of any one of clauses 1-17, further comprising one or more flavoring agents, plant proteins, lecithins, preservatives, calcium-containing agents, coloring agents, pH-modifying agents, anti-caking agents, film formers, salts, sugars, or combinations thereof.
Clause 19. The composition of any one of clauses 1-18, wherein the composition has increased chewiness and springiness properties and reduced stickiness properties as compared to a composition that does not comprise an insoluble fiber.
Clause 20. The composition of any one of clauses 1-19, wherein the composition has improved melt properties as compared to a composition that does not comprise one or more starches, one or more oils, and a vegan cultured base.
Clause 21. A method of making a plant-based cheese-style composition, the method comprising: (a) mixing a vegan cultured base with heated water to create a base mixture; (b) shear mixing one or more oils with the base mixture to create a dispersion of particles; (c) shear mixing an insoluble fiber with the dispersion of particles to create a fiber mixture; (d) heating the fiber mixture; (e) shear mixing one or more starches and proteins with the heated fiber mixture to create a starch-protein blend; (f) heating the blend; and (g) refrigerating the heated blend to create the plant-based cheese-style composition.
Clause 22. The method of clause 21, wherein one or more of the pH, solids content, or moisture content of the heated blend is adjusted prior to refrigerating.
Clause 23. The method of clause 21 or clause 22, wherein the heated blend is provided to a mold or container prior to refrigerating.
Clause 24. The method of any one of clauses 21-23, further comprising mixing one or more gums, flavoring agents, plant proteins, lecithins, preservatives, calcium-containing agents, coloring agents, pH-modifying agents, anti-caking agents, film formers, salts, sugars, or combinations thereof to the heated water, base mixture, oil, dispersion of particles, fiber mixture, starch-protein blend, plant-based cheese-style composition, or combinations thereof.
Clause 25. The method of any one of clauses 21-24, further comprising performing one or more additional processing steps to the plant-based cheese-style composition comprising cutting, shredding, dicing, crumbling, shaping, slicing, freezing, preserving, storing, packaging, or combinations thereof.
Clause 26. The method of any one of clauses 21-25, wherein the heated water comprises a temperature ranging from about 50° C. to about 70° C.
Clause 27. The method of any one of clauses 21-26, wherein the one or more oils is pre-heated to a temperature ranging from about 40° C. to about 60° C. prior to shear mixing with the base mixture.
Clause 28. The method of any one of clauses 21-27, wherein the insoluble fiber comprises bamboo fiber, rice fiber, wheat fiber, oat fiber, or combinations thereof.
Clause 29. The method of any one of clauses 21-28, wherein the insoluble fiber is pre-blended prior to shear mixing with the dispersion of particles.
Clause 30. The method of any one of clauses 21-29, further comprising one or more additional heating steps.
Clause 31. The method of any one of clauses 21-30, wherein heating comprises a temperature ranging from about 55° C. to about 95° C.
Clause 32. The method of any one of clauses 21-31, wherein refrigerating comprises a temperature ranging from about 2° C. to about 7° C.
Clause 33. The method of any one of clauses 21-32, wherein shear mixing comprises a shear speed ranging between about 2,000 rpm to about 12,000 rpm or ranging between about 33 Hz to about 200 Hz.

1. A plant-based cheese-style composition comprising:
(a) an insoluble fiber comprising bamboo fiber, rice fiber, wheat fiber, oat fiber, or combinations thereof;
(b) one or more starches;
(c) one or more oils;
(d) a vegan cultured base; and
(e) water.

2. The composition of claim 1, wherein the insoluble fiber comprises bamboo fiber in an amount ranging from about 1.5 wt % to about 4.5 wt % of the plant-based cheese-style composition.

3. The composition of claim 2, wherein the bamboo fiber is present in an amount of about 3 wt % of the plant-based cheese-style composition.

4. The composition of claim 1, wherein the insoluble fiber comprises an average fiber length ranging from about 30 μm to about 200 μm.

5. The composition of claim 4, wherein the insoluble fiber comprises an average fiber length ranging from about 100 μm to about 120 μm.

6. The composition of claim 4, wherein the insoluble fiber comprises an average fiber length of about 115 μm.

7. The composition of claim 1, wherein the insoluble fiber comprises an average fiber thickness ranging from about 1 μm to about 40 μm.

8. The composition of claim 7, wherein the insoluble fiber comprises an average fiber thickness of about 20 μm.

9. The composition of claim 1, wherein the one or more starches comprises one or more emulsifying starches, one or more viscosifying starches, or a combination thereof.

10. The composition of claim 9, wherein the one or more emulsifying starches comprises an emulsifying potato starch, and wherein the one or more viscosifying starches comprises a viscosifying potato starch.

11. The composition of claim 9, wherein the one or more emulsifying starches is present in an amount ranging from about 3.5 wt % to about 9 wt % of the plant-based cheese-style composition, and wherein the one or more viscosifying starches is present in an amount ranging from about 9.5 wt % to about 22 wt % of the plant-based cheese-style composition.

12. The composition of claim 1, further comprising one or more gums or hydrocolloids comprising gellan gum, Konjac gum, hydroxypropyl methylcellulose (HPMC), xanthan gum, or combinations thereof.

13. The composition of claim 12, wherein gellan gum is present in an amount ranging from about 0.1 wt % to about 0.3 wt % of the plant-based cheese-style composition, Konjac gum is present in an amount ranging from about 0.1 wt % to about 0.3 wt % of the plant-based cheese-style composition, HPMC is present in an amount up to 0.5 wt % of the plant-based cheese-style composition, xanthan gum is present in an amount up to 0.19 wt % of the plant-based cheese-style composition, or a combination thereof.

14. The composition of claim 1, wherein the one or more oils comprises coconut oil, sunflower oil, canola oil, or combinations thereof.

15. The composition of claim 1, wherein the one or more oils is present in an amount ranging from about 15 wt % to about 23 wt % of the plant-based cheese-style composition.

16. The composition of claim 1, wherein the vegan cultured base comprises one or more bacterial strains comprising Streptococcus thermophilus, Lactobacillus delbrueckii subsp. bulgaricus, Lactobacillus delbrueckii subsp. lactis, Bifidobacterium lactis, Lactobacillus acidophilus, Lactobacillus paracasei, Lactobacillus casei, or combinations thereof.

17. The composition of claim 1, wherein the vegan cultured base is present in an amount ranging from about 15 wt % to about 30 wt % of the plant-based cheese-style composition.

18. The composition of claim 1, further comprising one or more flavoring agents, plant proteins, lecithins, preservatives, calcium-containing agents, coloring agents, pH-modifying agents, anti-caking agents, film formers, salts, sugars, or combinations thereof.

19. The composition of claim 1, wherein the composition has increased chewiness and springiness properties and reduced stickiness properties as compared to a composition that does not comprise an insoluble fiber.

20. The composition of claim 1, wherein the composition has improved melt properties as compared to a composition that does not comprise one or more starches, one or more oils, and a vegan cultured base.

21. A method of making a plant-based cheese-style composition, the method comprising:
(a) mixing a vegan cultured base with heated water to create a base mixture;
(b) shear mixing one or more oils with the base mixture to create a dispersion of particles;
(c) shear mixing an insoluble fiber with the dispersion of particles to create a fiber mixture;
(d) heating the fiber mixture;
(e) shear mixing one or more starches and proteins with the heated fiber mixture to create a starch-protein blend;
(f) heating the blend; and
(g) refrigerating the heated blend to create the plant-based cheese-style composition.

22. The method of claim 21, wherein one or more of the pH, solids content, or moisture content of the heated blend is adjusted prior to refrigerating.

23. The method of claim 21, wherein the heated blend is provided to a mold or container prior to refrigerating.

24. The method of claim 21, further comprising mixing one or more gums, flavoring agents, plant proteins, lecithins, preservatives, calcium-containing agents, coloring agents, pH-modifying agents, anti-caking agents, film formers, salts, sugars, or combinations thereof to the heated water, base mixture, oil, dispersion of particles, fiber mixture, starch-protein blend, plant-based cheese-style composition, or combinations thereof.

25. The method of claim 21, further comprising performing one or more additional processing steps to the plant-based cheese-style composition comprising cutting, shredding, dicing, crumbling, shaping, slicing, freezing, preserving, storing, packaging, or combinations thereof.

26. The method of claim 21, wherein the heated water comprises a temperature ranging from about 50° C. to about 70° C.

27. The method of claim 21, wherein the one or more oils is pre-heated to a temperature ranging from about 40° C. to about 60° C. prior to shear mixing with the base mixture.

28. The method of claim 21, wherein the insoluble fiber comprises bamboo fiber, rice fiber, wheat fiber, oat fiber, or combinations thereof.

29. The method of claim 21, wherein the insoluble fiber is pre-blended prior to shear mixing with the dispersion of particles.

30. The method of claim 21, further comprising one or more additional heating steps.

31. The method of claim 21, wherein heating comprises a temperature ranging from about 55° C. to about 95° C.

32. The method of claim 21, wherein refrigerating comprises a temperature ranging from about 2° C. to about 7° C.

33. The method of claim 21, wherein shear mixing comprises a shear speed ranging between about 2,000 rpm to about 12,000 rpm or ranging between about 33 Hz to about 200 Hz.
